(19) United States
(12) Patent Application Publication
(10) Pub. No.: US 2002/0188663 A1
(43) Pub. Date: Dec. 12, 2002

(54) Multi-agent system for digital home/office

(76) Inventors: Farhad Fuad Islam, Apex, NC (US); Mikhail Prokopenko, Lane Cove (AU); Michael Alexander Oldfield, Eastwood (AU)

Correspondence Address: FITZPATRICK CELLA HARPER & SCINTO, 30 ROCKEFELLER PLAZA, NEW YORK, NY, 10112, US

(21) Appl. No.: 10/125,378

(22) Filed: Apr. 19, 2002

(30) Foreign Application Priority Data
Apr. 24, 2001 (AU) PR4598

(51) Int. Cl. G06F 15/16

(52) U.S. Cl. 709/202; 709/226

(57) ABSTRACT

A method (1800) for controlling a system comprising a plurality of appliances, each said appliance having a corresponding appliance agent, and a user agent, associated with a user is disclosed. The method detecting (1802) an interaction of the user with a corresponding first appliance, communicating (1804) this to the user agent to thereby update a user profile, sending (1808) a first action message dependent upon the user profile and upon said one of the interaction to the first appliance agent to direct the corresponding first appliance to perform a first action, wherein control over said first action thereby passes from the user agent to the first appliance agent. The method farther comprises sending (1816) a second action message dependent upon the first action message if the first appliance cannot perform the necessary action to a second appliance agent, thereby to direct a corresponding second appliance to perform a second action, wherein control over said second action thereby passes from the first appliance agent to the second appliance agent.

### TECHNICAL FIELD

The present invention relates generally to software agents and, in particular, to software agents in a networked home or office environment. The present invention relates to a method and system for controlling one or more networked appliances. The invention also relates to a computer program product including a computer readable medium having recorded thereon a computer program for controlling one or more appliances.

### BACKGROUND

Intelligent appliances which have sensors to receive and analyse environmental signals, and effectors to respond as a function of the sensed signals, are known. Thus, for example, some microwave ovens can sense the defrosting state of frozen food, and can adjust the defrosting power accordingly.

Appliances have also been provided with sensor interfaces for interconnection to a system of appliances. The complexity of control and sensing options provided by such a system of appliances however, presents a burden to a user who merely wants to use the appliances effectively, and does not want to spend effort on system control issues.

### SUMMARY OF THE INVENTION

It is an object of the present invention to substantially overcome, or at least ameliorate, one or more disadvantages of existing arrangements.

According to a first aspect of the invention, there is provided a method for controlling a system comprising a user agent, associated with a user, and a plurality of appliances each having a corresponding appliance agent, said method comprising steps of:

sending, by the user agent, a first action message to a first appliance agent, thereby to direct a corresponding first appliance to perform a first action, wherein control over said first action thereby passes from the user agent to the first appliance agent;

performing said first action by the first corresponding appliance if said first corresponding appliance is capable of doing so; and

sending, by the first appliance agent, if the first corresponding appliance is not capable of performing the first action, a second action message dependent upon the first action message to a second appliance agent, thereby to direct a corresponding second appliance to perform a second action; wherein control over said second action thereby passes from the first appliance agent to the second appliance agent.

According to another aspect of the invention, there is provided a system for controlling a plurality of appliances, the system including a user agent, associated with a user, and said plurality of appliances each having a corresponding appliance agent, wherein:

the user agent includes sending means for sending a first action message to a first appliance agent, thereby to direct a corresponding first appliance to perform a first action, wherein control over said first action thereby passes from the user agent to the first appliance agent; and

the first appliance agent includes sending means for sending, if the first corresponding appliance is not capable of performing the first action, a second action message dependent upon the first action message to a second appliance agent, thereby to direct a corresponding second appliance to perform a second action; wherein control over said second action thereby passes from the first appliance agent to the second appliance agent.

According to another aspect of the invention, there is provided a computer program product including a computer readable medium having recorded thereon at least one computer program module for directing at least one corresponding processor to execute a method for controlling a plurality of appliances in a system comprising a user agent, associated with a user, and corresponding appliance agents for the plurality of appliances, said at least one computer program module comprising:

code for sending, by the user agent, a first action message to a first appliance agent, thereby to direct a corresponding first appliance to perform a first action, wherein control over said first action thereby passes from the user agent to the first appliance agent; and

code for sending, by the first appliance agent, if the first corresponding appliance is not capable of performing the first action, a second action message dependent upon the first action message to a second appliance agent, thereby to direct a corresponding second appliance to perform a second action; wherein control over said second action thereby passes from the first appliance agent to the second appliance agent.

According to another aspect of the invention, there is provided a computer program comprising at least one computer program module for directing at least one corresponding processor to execute a method for controlling a plurality of appliances in a system comprising a user agent, associated with a user, and corresponding appliance agents for the plurality of appliances, said at least one computer program module comprising:

code for sending, by the user agent, a first action message to a first appliance agent, thereby to direct a corresponding first appliance to perform a first action, wherein control over said first action thereby passes from the user agent to the first appliance agent; and

code for sending, by the first appliance agent, if the first corresponding appliance is not capable of performing the first action, a second action message dependent upon the first action message to a second appliance agent, thereby to direct a corresponding second appliance to perform a second action; wherein control over said second action thereby passes from the first appliance agent to the second appliance agent.

According to another aspect of the invention, there is provided a television signal receiving apparatus being capable of communicating with a plurality of appliances, said television signal receiving apparatus comprising a signal receiving means for receiving a television signal, a user agent associated with a user, and a plurality of appliance agents each associated with a corresponding one of said appliances, wherein:

the user agent includes sending means for sending a first action message to a first appliance agent, thereby to direct a corresponding first appliance to perform a first action, wherein control over said first action thereby passes from the user agent to the first appliance agent; and

the first appliance agent includes sending means for sending, if the first corresponding appliance is not capable of performing the first action, a second action message dependent upon the first action message to a second appliance agent, thereby to direct a corresponding second appliance to perform a second action wherein control over said second action thereby passes from the first appliance agent to the second appliance agent.

According to another aspect of the invention, there is provided a method for controlling a system comprising a plurality of appliances, each said appliance having a corresponding appliance agent, and a user agent, associated with a user, said method comprising steps of:

detecting by a first appliance agent at least one of (i) an interaction of the user with a corresponding first appliance, and (ii) an event associated with said corresponding first appliance;

communicating by the first appliance agent to the user agent, an updating message dependent upon said at least one of said interaction and said event;

updating a user profile by the user agent dependent upon said updating message;

sending, by the user agent, a first action message dependent upon the user profile and upon said one of the interaction and the event to the first appliance agent, thereby to direct the corresponding first appliance to perform a first action; wherein control over said first action thereby passes from the user agent to the first appliance agent;

performing said first action by the first corresponding appliance if a first status of the first appliance so permits; and

sending, if the first status does not so permit, by the first appliance agent, a second action message dependent upon the first action message and the first status to a second appliance agent, thereby to direct a corresponding second appliance to perform a second action; wherein control over said second action thereby passes from the first appliance agent to the second appliance agent.

According to another aspect of the invention, there is provided a system for controlling a plurality of appliances, each said appliance having a corresponding appliance agent, the system including a user agent, associated with a user, wherein:

(a) a first one of said corresponding appliance agents includes:

detecting means for detecting at least one of (i) an interaction of the user with a corresponding first appliance, and (ii) an event associated with said corresponding first appliance; and

communicating means for communicating to the user agent, an updating message dependent upon said at least one of said interaction and said event;

(b) the user agent includes:

updating means for updating a user profile dependent upon said updating message; and

sending means for sending a first action message dependent upon the user profile and upon said one of the interaction and the event to the first appliance agent, thereby to direct the corresponding first appliance to perform a first action; wherein control over said first action thereby passes from the user agent to the first appliance agent; and wherein:

(c) said first one of said corresponding appliance agents further includes sending means for sending, if a first status of the first corresponding appliance does not permit the first corresponding appliance to perform the first action, a second action message dependent upon the first action message and the first status to a second appliance agent, thereby to direct a corresponding second appliance to perform a second action; wherein control over said second action thereby passes from the first appliance agent to the second appliance agent.

According to another aspect of the invention, there is provided a computer program product including a computer readable medium having recorded thereon at least one computer program module for directing at least one corresponding processor to execute a method for controlling a plurality of appliances in a system comprising a user agent, associated with a user, and corresponding appliance agents for the plurality of appliances, said at least one computer program module comprising:

code for detecting by a first appliance agent at least one of (i) an interaction of the user with a corresponding first appliance, and (ii) an event associated with said corresponding first appliance;

code for communicating by the first appliance agent to the user agent, an updating message dependent upon said at least one of said interaction and said event;

code for updating a user profile by the user agent dependent upon said updating message;

code for sending, by the user agent, a first action message dependent upon the user profile and upon said one of the interaction and the event to the first appliance agent, thereby to direct the corresponding first appliance to perform a first action; wherein control over said first action thereby passes from the user agent to the first appliance agent; and

code for sending, if the first status does not so permit, by the first appliance agent, a second action message dependent upon the first action message and the first status to a second appliance agent, thereby to direct a corresponding second appliance to perform a second action; wherein control over said second action thereby passes from the first appliance agent to the second appliance agent.

According to another aspect of the invention, there is provided a computer program comprising at least one computer program module for directing at least one corresponding processor to execute a method for controlling a plurality of appliances in a system comprising a user agent, associated with a user, and corresponding appliance agents for the plurality of appliances, said at least one computer program module comprising:

code for detecting by a first appliance agent at least one of (i) an interaction of the user with a corresponding first appliance, and (ii) an event associated with said corresponding first appliance;

code for communicating by the first appliance agent to the user agent, an updating message dependent upon said at least one of said interaction and said event;

code for updating a user profile by the user agent dependent upon said updating message;

code for sending, by the user agent, a first action message dependent upon the user profile and upon said one of the interaction and the event to the first appliance agent, thereby to direct the corresponding first appliance to perform a first action; wherein control over said first action thereby passes from the user agent to the first appliance agent; and

code for sending, if the first status does not so permit, by the first appliance agent, a second action message dependent upon the first action message and the first status to a second appliance agent, thereby to direct a corresponding second appliance to perform a second action; wherein control over said second action thereby passes from the first appliance agent to the second appliance agent.

According to another aspect of the invention, there is provided a system for controlling at least one appliance, the system comprising:

an appliance agent adapted to sense an interaction of a user with the at least one appliance;

a user agent associated with the user;

communicating means for communicating data between the appliance agent and the user agent, said data being dependent upon the interaction;

updating means for updating by the user agent a user profile in accordance with the data;

detecting means for detecting by the user agent an event associated with said at least one appliance; and

directing means for providing, by the user agent, a direction based upon at least one of the user profile and the event, to the at least one appliance if a criterion is satisfied.

According to another aspect of the invention, there is provided a method of controlling at least one appliance, said method comprising steps of:

sensing by an appliance agent an interaction of a user with the at least one appliance;

communicating data between the appliance agent and a user agent, said data being dependent upon the interaction;

updating by the user agent a user profile in accordance with the data;

detecting by the user agent an event associated with said at least one appliance; and

providing, by the user agent, a direction based upon at least one of the user profile and the event, to the at least one appliance if a criterion is satisfied.

According to another aspect of the invention, there is provided a computer readable medium for storing a program for a system for controlling at least one appliance, said program comprising:

code for a sensing step for sensing by an appliance agent an interaction of a user with the at least one appliance;

code for a communicating step for communicating data between the appliance agent and a user agent, said data being dependent upon the interaction;

code for an updating step for updating by the user agent a user profile in accordance with the data;

code for a detecting step for detecting by the user agent an event associated with said at least one appliance; and

code for a providing step for providing, by the user agent, a direction based upon at least one of the user profile and the event, to the at least one appliance if a criterion is satisfied.

According to another aspect of the invention, there is provided a user agent computer program for directing a processor to execute a method for controlling an appliance having an associated appliance agent computer program, the user agent program comprising:

code for receiving an updating message from the appliance agent, said updating message being dependent upon at least one of (i) an interaction of a user with the appliance, and (ii) an event associated with said appliance;

code for updating a user profile dependent upon the updating message; and

code for sending an action message dependent upon the user profile and said at least one of (i) the interaction and (ii) the event, to the appliance agent, thereby to direct the appliance to perform a first action, wherein control over said first action thereby passes from the user agent to the appliance agent.

According to another aspect of the invention, there is provided a computer program product including a computer readable medium having recorded thereon a user agent computer program for directing a processor to execute a method for controlling an appliance having an associated appliance agent computer program, the user agent program comprising:

code for receiving an updating message from the appliance agent, said updating message being dependent upon at least one of (i) an interaction of a user with the appliance, and (ii) an event associated with said appliance;

code for updating a user profile dependent upon the updating message; and

code for sending an action message dependent upon the user profile and said at least one of (i) the interaction and (ii) the event, to the appliance agent, thereby to direct the appliance to perform a first action, wherein control over said first action thereby passes from the user agent to the appliance agent.

According to another aspect of the invention, there is provided an appliance agent computer program associated with an appliance, said program adapted for directing a processor of the appliance to execute a method for controlling the appliance, the program comprising:

code for receiving a first action message from a user agent;

code for directing the appliance to perform a first action based upon the first action message;

code for amending the first action message to be intelligible to other appliance agent, if the appliance is unable to perform the first action; and

code for sending the amended action message to the other appliance agent, wherein control over said first action thereby passes to the other appliance agent.

According to another aspect of the invention, there is provided a computer program product including a computer readable medium having recorded thereon an appliance agent computer program associated with an appliance, said program adapted for directing a processor of the appliance to execute a method for controlling the appliance, the program comprising:

code for receiving a first action message from a user agent;

code for directing the appliance to perform a first action based upon the first action message;

code for amending the first action message to be intelligible to another appliance agent, if the appliance is unable to perform the first action; and

code for sending the amended action message to the other appliance agent, wherein control over said first action thereby passes to the other appliance agent.

According to another aspect of the invention, there is provided an inter agent server computer program adapted for directing a processor of an appliance to execute a method for controlling the appliance, the program comprising:

code for receiving a query from an appliance agent, said query requesting identification of a suitable alternate appliance to perform an action;

code for querying an inter agent server database to thereby identify said suitable alternate appliance on the basis of relevant information for a plurality of alternate appliances registered by the inter agent server;

code for selecting the suitable alternate appliance on the basis of the action; and

code for advising the appliance agent of the suitable alternate appliance.

According to another aspect of the invention, there is provided a computer program product including a computer readable medium having recorded thereon an appliance agent computer program associated with an appliance, said program adapted for directing a processor of the appliance to execute a method for controlling the appliance, the program comprising:

code for receiving a query from an appliance agent, said query requesting identification of a suitable alternate appliance to perform an action;

code for querying an inter agent server database to thereby identify said suitable alternate appliance on the basis of relevant information for a plurality of alternate appliances registered by the inter agent server;

code for selecting the suitable alternate appliance on the basis of the action; and

code for advising the appliance agent of the suitable alternate appliance.

### BRIEF DESCRIPTION OF THE DRAWINGS

A number of embodiments of the present invention will now be described with reference to the drawings, in which:

FIG. 1 shows a functional block representation of a multi-agent system;

FIG. 2 shows one example of a system according to FIG. 1;

FIG. 3 is a schematic block diagram of a general purpose computer upon which the described arrangements can be practiced;

FIG. 4 shows a first simplified exemplary block diagram representation of a multi-agent system;

FIG. 5 shows the system of FIG. 1 extended to a broader network environment;

FIG. 6 shows a block representation of the platform of FIG. 1;

FIG. 7 shows an Inter-Agent Server communicating with a number of agents;

FIG. 8 shows a first process depicted as a sequence of method steps by which an appliance in the system of FIG. 1 is controlled;

FIG. 9 shows a second process depicted as a sequence of method steps by which an appliance in the system of FIG. 1 is controlled;

FIG. 10 shows a second simplified exemplary block diagram representation of a multi-agent system;

FIG. 11 shows a block diagram representation of databases used by a user agent, and “instance” files stored in those databases;

FIG. 12 shows an example of a learning process used in the system of FIG. 10;

FIG. 13 shows an example of a reasoning process used in the system of FIG. 10;

FIGS. 14 and 15 show an example of a planning process used in the system of FIG. 10;

FIG. 16 shows a data flow diagram, depicting use of the instance files by learning, reasoning and planning modules;

FIG. 17 shows a process by which multiple agents control a plurality of appliances using distributed control;

FIG. 18 is a flow chart of method steps comprising a process whereby an appliance agent participates in control of appliances in the multi-agent system;

FIG. 19 is a flow chart of method steps comprising a process whereby a user agent participates in control of appliances in the multi-agent system; and

FIG. 20 is a flow chart of method steps comprising a process whereby an Inter-agent server participates in control of appliances in the multi-agent system.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

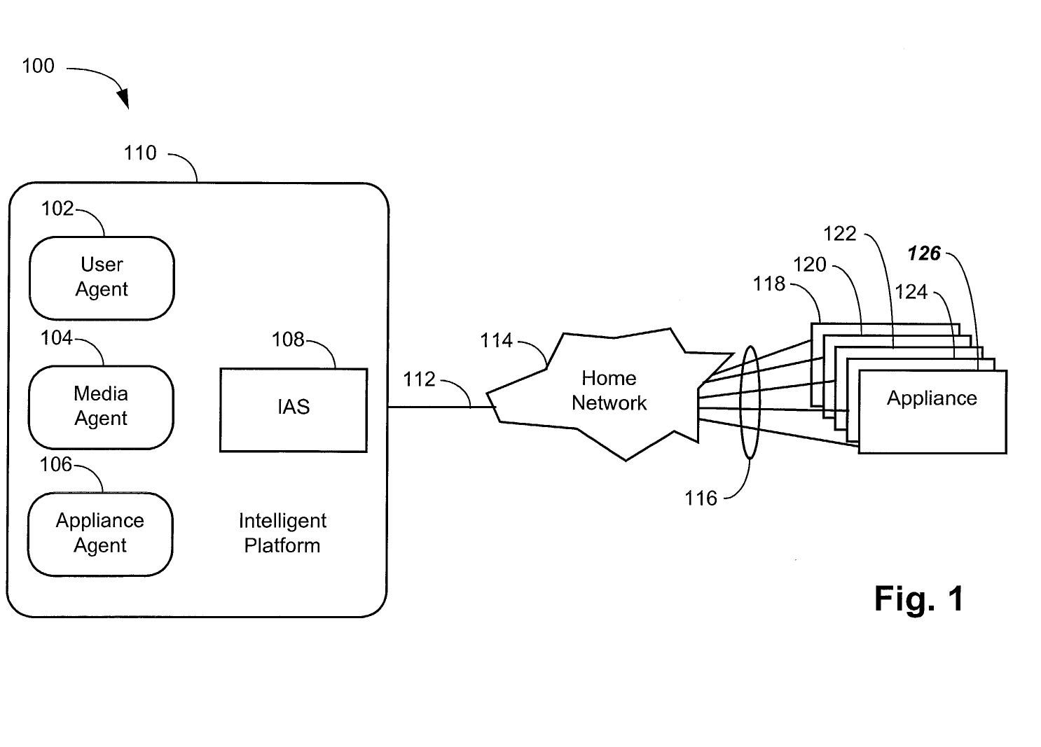

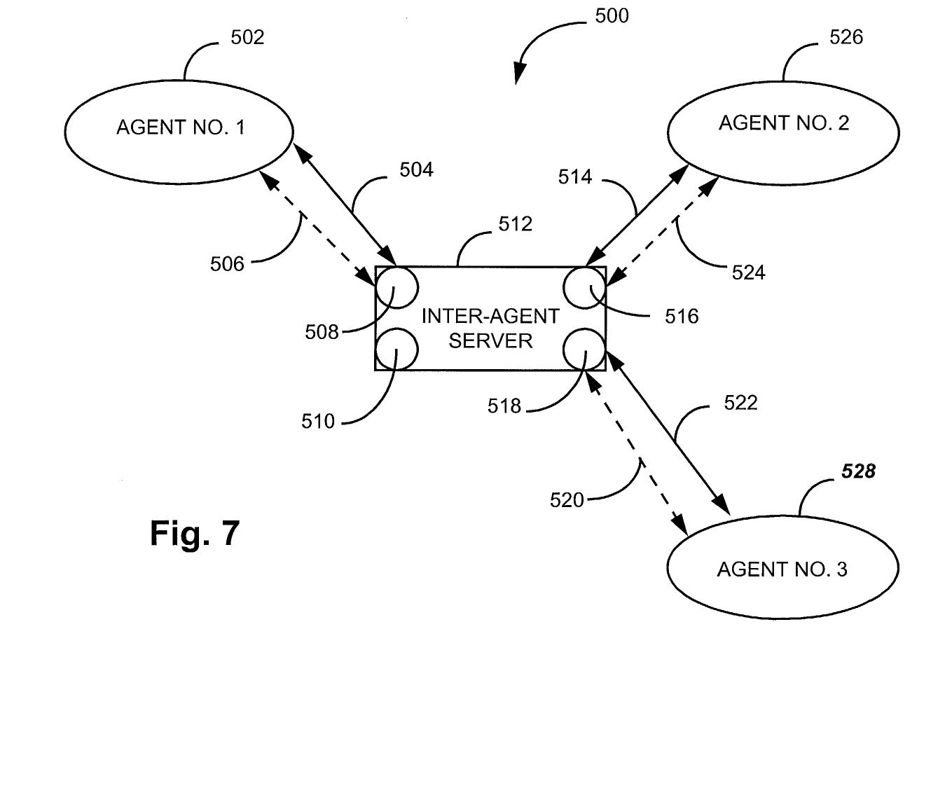

FIG. 1 shows a physical representation of a multi-agent system 100 in a home environment. A number of appliances 118 to 126 are connected by a set 116 of associated connections to a home network 114. The network 114 is connected by a connection 112 to an intelligent home platform 110 which contains a number of agents 102 to 106, and an Inter-Agent Server (IAS) 108. The IAS is described in more detail in relation to FIG. 7. The home platform 110 supports a software environment in which the software agent representations 106 of the physical appliances 118-126 reside. This software agent environment may also be supported by a personal computer (PC) (not shown), or alternatively, a set top box (STB) (not shown) which provides a communication and control interface between a television (TV) (not shown) and other devices and services across the network 114. A system similar to the system 100 can be implemented in an office environment. In an office situation the home network 114 is replaced by an office network, for example a Local Area Network (LAN). The appliances 118 to 126 are replaced, in this case, by office appliances (eg. photocopiers rather than video-cassette recorders (VCRs)).

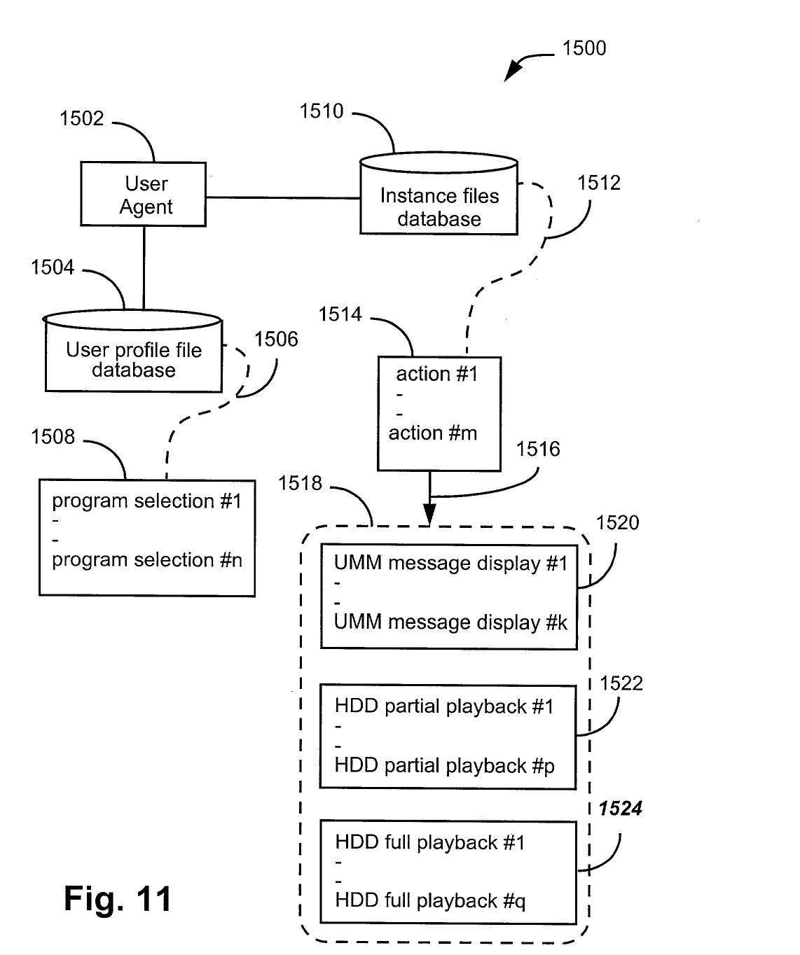

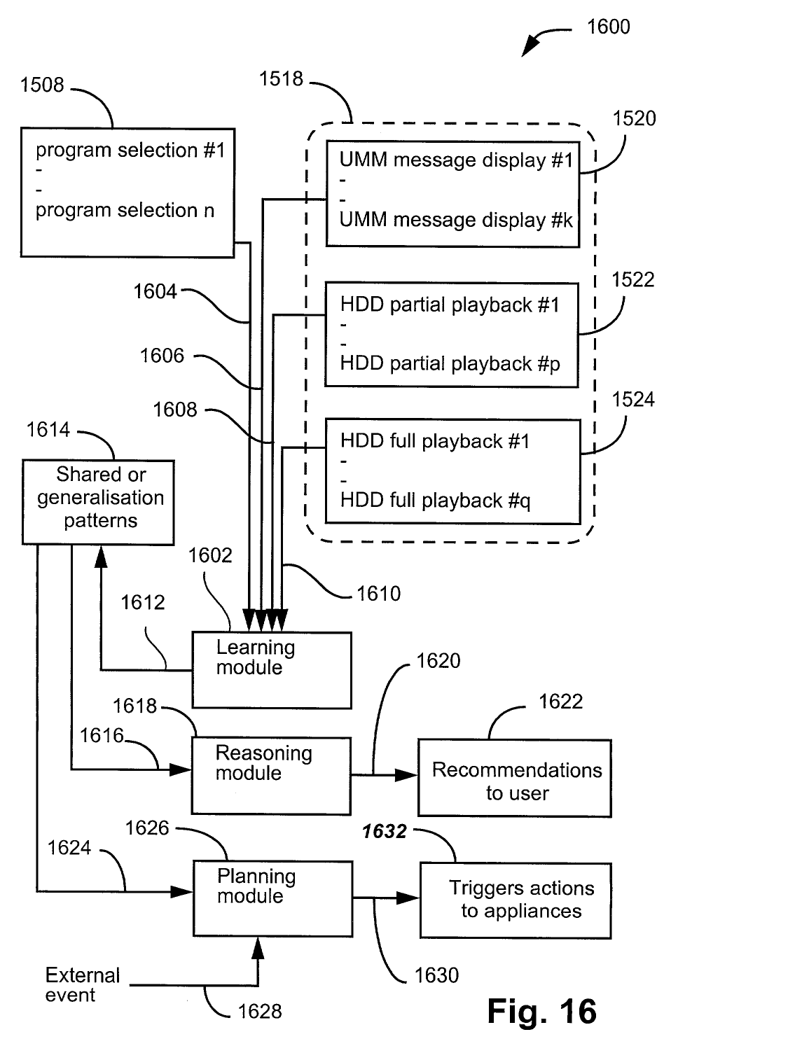

An agent is a software component, which typically uses external inputs along with an internal state to perform one or more tasks, the agent acting in a preset manner. Agents are characterised by a number of attributes, including one or more of (i) mobility, (ii) response method, (iii) autonomy, (iv) learning, and (v) cooperation. An exemplary agent architecture is described in relation to FIGS. 11 and 16, however commercially available agents may be adapted to perform the specific tasks.

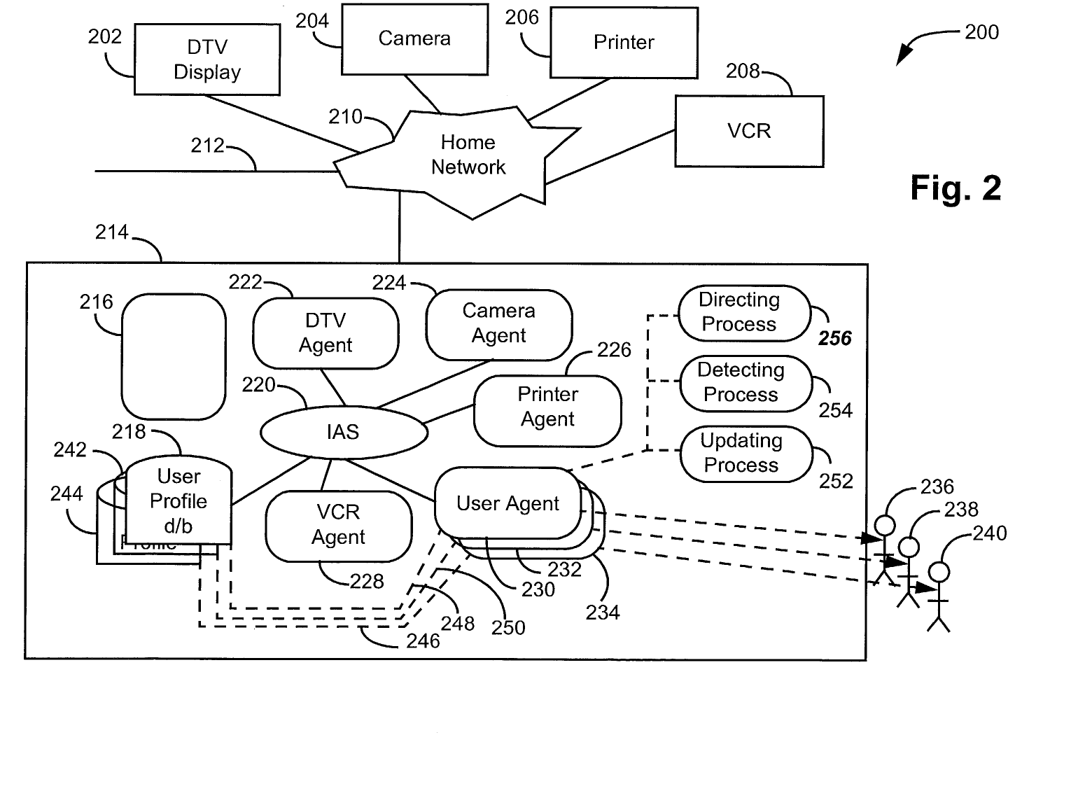

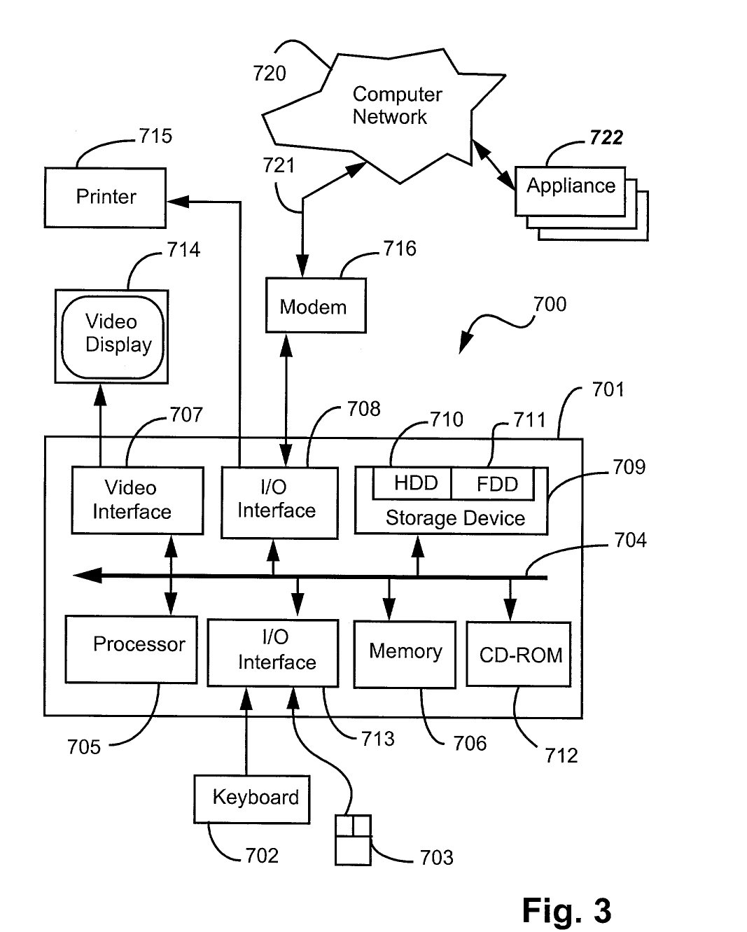

FIG. 2 shows a particular instance 200 of the system shown in FIG. 1. FIG. 2 relates in particular to a home environment, and shows a digital television receiver (DTV) 202, a camera 204, a printer 206, and a video-cassette recorder (VCR) 208, all connected to a home network 210. The home network 210 is connected to a second DTV 214, having a display area 216 which has been symbolically shrunk and placed in the top left hand corner of the pictorial representation of the DTV 214 to leave room for representation of further embedded functionality which will now be described. From a practical standpoint, the additional functionality now to be described can be incorporated into the DTV 214 itself, or alternately, into a set-top box (not shown explicitly) which may be suitably connected to the DTV 214.

An inter-agent server 220 is connected to a number of appliance agents, namely a DTV agent 222, a camera agent 224, a printer agent 226 and a VCR agent 228. These appliance agents are functionally associated with corresponding physical appliances. Accordingly, the DTV agent 222 is associated, ie. “paired” with the DTV 202, and the camera agent 224 is paired with the camera 204. The printer agent 226 is paired with the printer 206, and the VCR agent 228 is paired with the VCR 208. The objectives, or roles, for the appliance agents are primarily (i) to control the physical appliance in accordance with instruction/advice from user agents 230-234, and (ii) to gather, or collect appliance usage information as well as appliance status, and communicate these to the user agents 230-234 through the Inter Agent server 220.

The inter-agent server 220 is connected to a number of user profile databases 218, 242 and 244. These databases are functionally associated with the corresponding user agents 230, 232 and 234, the correspondence being depicted by dashed lines 248, 250 and 246 respectively. In the same manner that appliances 202-208 and appliance agents 222-228 are paired, user agents 230-234 and users 236-240 are also paired. Accordingly, the user agents 230, 232 and 234 are paired with users 236, 238 and 240 respectively.

The collection of software agents 220-234 along with the Inter-agent server 220 and the user profile databases 218, 242, 244 is called an “agent system” 214.

The agents 222-228 and 230-234 are software entities that act autonomously with minimum human user intervention. The agents interact with either a user eg. 236 or an appliance eg. 202 depending on the particular nature of the agent. Each agent typically operates to fulfil its role, as defined by an agent “goal”. The typical goal of an agent system is to provide service in order to attain maximum user satisfaction. One measure of user satisfaction is manifested by the degree of acceptance, or utilisation, by the user, of the service provided by an agent system. For example, in a DTV program recommendation ‘DTV-agent’ system, if a user accepts the recommended programs quickly without going through the whole list of recommendations, and without engaging in extensive channel browsing (surfing), then it can be concluded that the degree of user satisfaction is high. The agents require minimal user-initiated interaction. The agents make decisions while requiring minimum user intervention. The agents interact with other agents of their own volition. Core capabilities in agents can be implemented using artificial intelligence (AI) techniques to implement learning, reasoning and planning capabilities.

From a functional perspective, the user agent 230 operates in concert with the DTV-agent 222, in order to build a profile of behaviour of the user 236 in regard to the DTV 202. The profile is built in relation to the programs or operations of the DTV 202, and the user agent 230 updates, using an updating process 252, the user profile for the user 236 in the user profile database 218. The DTV agent 222 and the user agent 230 monitor the behaviour of the user 236 in relation to the DTV 202, learning the user's likes and habits in relation to the DTV 202. The profile for the user 236 which is stored in the database 218 can be used, for example, to recommend programs to the user 236 based upon the past behaviour of the user 236, and incorporating the aforementioned learning, reasoning and planning processes. The aforementioned learning, reasoning and planning behaviour is used to build up user profiles on a user-specific basis, and a user profile is developed for each user 236-240 in respect of each appliance 222-228. The user profiles 218, 242, 244 can incorporate cross-appliance user behaviour.

The user agent 230 that is associated with the user 236, is, as a result of the aforementioned communications from the appliance agents, aware of the behaviour of the user 236 in relation to each of the appliances 202-208. The user agent 230 maintains a memory of this behaviour in the form of the associated user profile for the user 236 in the user profile database 218. The appliance agent 222 in contrast, is concerned with the associated DTV 202, and does not retain any user-specific behavioural information relating to use of the DTV 202 by the user. The appliance agent 222 does, however, collaborate with the user agent 230, to build a profile for the user 236 in relation to the DTV 202. The appliance agent 222 also cooperates with the user agent 230 and performs control functions in relation to the DTV 202 in order to satisfy the user 236. This satisfaction is achieved by controlling operation of the DTV 202 according to criterion derived from the user profile, thereby increasing a satisfaction level of the user 236 in regard to operation of the DTV 202.

The user agent 230 is aware of the behaviour and preferences of the user 236 in regard to multiple appliances. This awareness is provided by the associated user profile, and enables user satisfaction of the user 236 to be improved in regard to the suite of appliances in question. Thus, for example, consider the situation in which the user 236 is watching soccer on the DTV 202. The personal computer agent (not shown), which in this example represents the user agent eg. 230, which is associated with the user's personal computer (PC) (not shown), detects, using a detecting process 254, that an e-mail for the user 236 has arrived. The user agent 230 then directs, using a directing process 256, the DTV agent 222 to notify the user 236 about the e-mail arrival by placing a suitable pop-up announcement on the screen of the DTV 202. The user agent 230 will however only follow this direction if the user profile of the user 236 indicates that the user 236 would wish to receive the particular e-mail in the given circumstances.

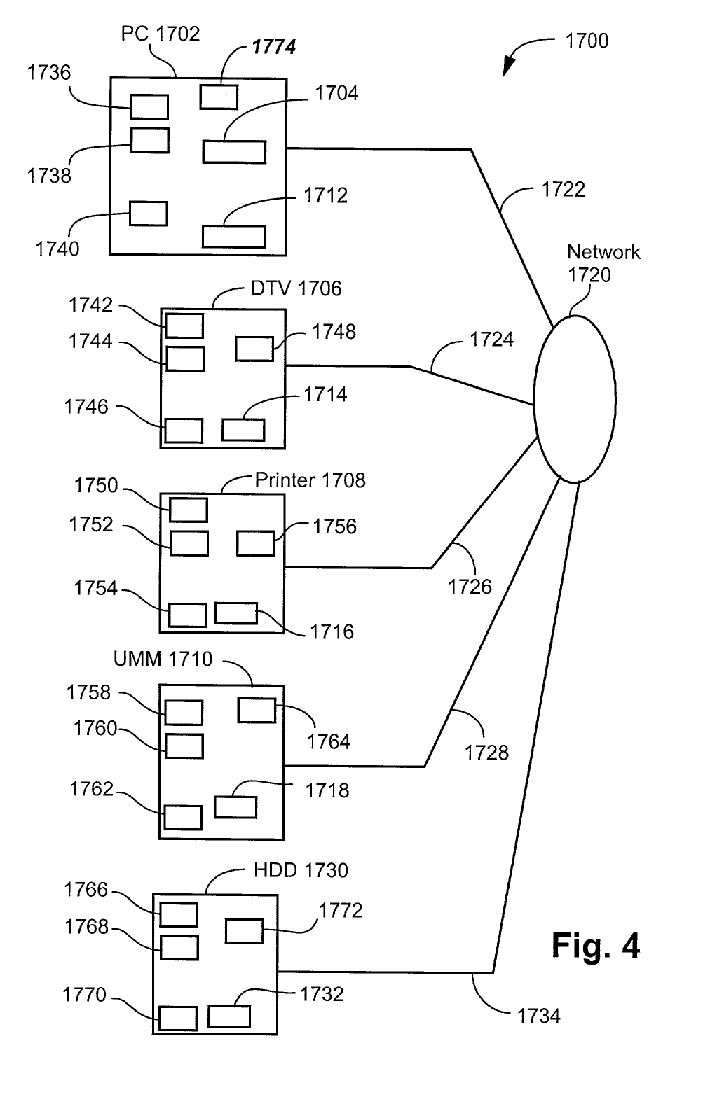

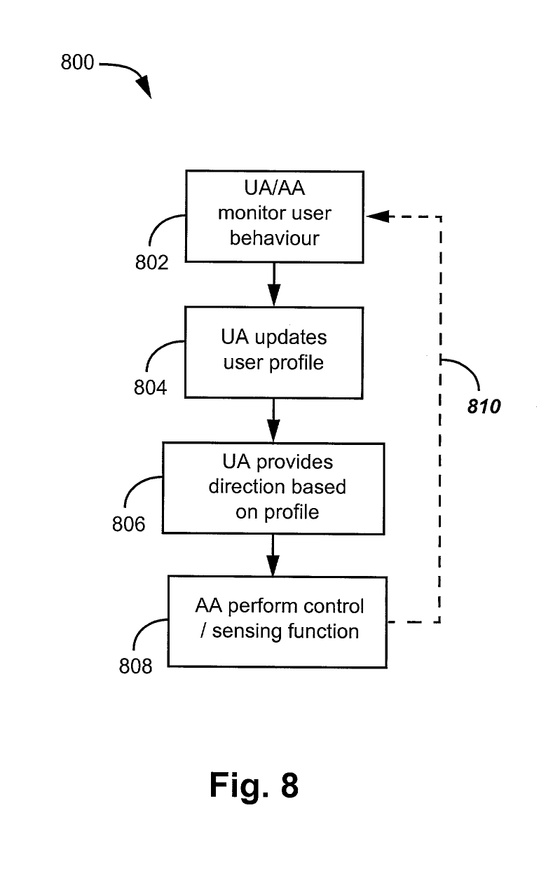

FIG. 3 shows how the method of controlling at least one appliance is preferably practiced using a conventional general-purpose computer system 700, wherein the processes of FIGS. 8, 9, 12-15 and 17 may be implemented as software, such as an application program executing within the computer system 700. It is noted that the system 700 comprises a computer module 701 and appliances, an example of which is designated by a reference numeral 722, wherein each appliance 722 can have therein (see FIG. 4) a general or special purpose computer processor including associated memory and interface modules. The computer hardware and software features provided in the appliances 722 need not be as comprehensive as those shown for the computer module 701. For example, the appliance processor arrangements need not generally include features such as keyboards, mouse devices, video displays, printers or associated I/O interfaces. Furthermore, the appliance processor arrangements may not include floppy disk drives or CD-ROM drives.

Software appliance agents that will be described in relation to FIG. 4 preferably reside in memory in the corresponding appliances. Alternately the appliance agent software may reside in memory elsewhere, such as in the intelligent platform 110 (see FIG. 1) which will typically be implemented using a computer module 701 described in more detail below, or alternately, in memory in the DTV 214. Accordingly, the software programs for the appliance and user agents may be distributed in a variety of convenient fashions throughout the various memory devices in the system 700, without affecting their functional behaviour. The operation of each appliance computer arrangement is generally equivalent to that described in more detail below in regard to the computer module 701.

Having regard to the computer module 701, the method steps for controlling at least one appliance are effected by instructions in the software that are carried out by the various elements in the computer system 700. The software may be divided into two separate parts, one part for carrying out the controlling of at least one appliance, and another part to manage the user interface between the latter and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for controlling at least one appliance.

The computer system 700 comprises a computer module 701, input devices such as a keyboard 702 and mouse 703, output devices including a printer 715 and a display device 714. A Modulator-Demodulator (Modem) transceiver device 716 is used by the computer module 701 for communicating to and from a communications network 720, for example connectable via a telephone line 721 or other functional medium. The modem 716 can be used to obtain access to the Internet, and other network systems, such as a Local Area Network (LAN) or a Wide Area Network (WAN). Also accessible across the network 720 is a plurality of appliances exemplified by the appliance 722.

The computer module 701 typically includes at least one processor unit 705, a memory unit 706, for example formed from semiconductor random access memory (RAM) and read only memory (ROM), input/output (I/O) interfaces including a video interface 707, and an I/O interface 713 for the keyboard 702 and mouse 703 and optionally a joystick (not illustrated), and an interface 708 for the modem 716. A storage device 709 is provided and typically includes a hard disk drive 710 and a floppy disk drive 711. A magnetic tape drive (not illustrated) may also be used. A CD-ROM drive 712 is typically provided as a non-volatile source of data. The components 705 to 713 of the computer module 701, typically communicate via an interconnected bus 704 and in a manner which results in a conventional mode of operation of the computer system 700 known to those in the relevant art. Examples of computers on which the embodiments can be practised include IBM-PC's and compatibles, Sun Sparcstations or alike computer systems evolved therefrom.

Typically, the application program is resident on the hard disk drive 710 and read and controlled in its execution by the processor 705. Intermediate storage of the program and any data fetched from the network 720 may be accomplished using the semiconductor memory 706, possibly in concert with the hard disk drive 710. In some instances, the application program may be supplied to the user encoded on a CD-ROM or floppy disk and read via the corresponding drive 712 or 711, or alternatively may be read by the user from the network 720 via the modem device 716. Still further, the software can also be loaded into the computer system 700, both in regard to the computer module 701 and the appliances 722, from other computer readable medium including magnetic tape, a ROM or integrated circuit, a magneto-optical disk, a radio or infra-red transmission channel between the computer module 701 and another device, a computer readable card such as a PCMCIA card, and the Internet and Intranets including email transmissions and information recorded on websites and the like. The foregoing is merely exemplary of relevant computer readable media. Other computer readable mediums may be practiced. As described in relation to FIG. 2, software entities representing the inter agent server, the user agent(s) and the appliance agent(s) can be distributed across the general computer system 700 and the appliance 722 in various ways. Provided that the functional interrelationship between these entities, as described for example in relation to FIG. 2, is provided, the physical location of the entities (ie. the IAS and the agents) is not important. Accordingly the corresponding physical software and functional program modules can be distributed as desired among the processor entities in the computer module 701 and the appliances 722.

The method of controlling at least one appliance may alternatively be implemented in dedicated hardware such as one or more integrated circuits performing the functions or sub functions of controlling at least one appliance. Such dedicated hardware may include graphic processors, digital signal processors, or one or more microprocessors and associated memories.

FIG. 4 shows one example of an implementation 1700 of a multi-agent system. An Inter-Agent Server (IAS) is implemented by means of an application 1704 running on a PC 1702. A second application 1712 also running on the PC 1702 implements a user agent. A third application 1774 also running on the PC 1702 implements a Personal Computer Agent (PCA). Like the system 700 previously described (see FIG. 3) the PC 1702 comprises a central processing unit (CPU) 1736, a memory 1738 which can comprise read only memory (ROM) and random access memory (RAM) elements, as well as a keyboard 1740 for interacting with a user. In addition to the three applications 1704, 1774 and 1712 running on the PC 1702, there are further applications for each of four appliance agents, namely a DTV agent application 1714, a Printer agent application 1716, a UMM agent 1718 (which is the agent for a Unified Messaging Module 1710, which can receive and store communications, such as electronic mail or facsimile transmissions respectively), and an HDD agent application 1732 (which is the agent for a storage medium, such as a Hard-Disk Drive 1730, referred to as an HDD). The terms “agent”, and “agent process”, and “agent application” are used interchangeably, the specific usage intended being clear from the context unless made otherwise explicit.

A DTV 1706, in which the DTV agent application 1714 resides, has a CPU 1742, a memory device 1744, a sensor 1746 and an effector 1748. The sensor 1746, having regard to processing of emails in the system 1700, is a special purpose software module that is responsive to an email category probability measure that is described below. The effector 1748, having regard to processing of emails in the system 1700, is a special purpose software module that can display the email on the screen of the DTV 1706.

A printer 1708, in which the printer agent application 1716 resides, has an CPU 1750, a memory device 1752, a sensor 1754 and an effector 1756. The sensor 1754, in the present example, is adapted to sense availability of paper in the printer. The effector 1756 is a print head that can print the email on the paper in the printer 1708.

A UMM 1710, in which the UMM agent application 1718 resides, has a CPU 1758, a memory device 1760, a sensor 1762, and an effector 1764. The sensor 1762, in the present example, is adapted to sense availability of storage capacity in the UMM 1710. The effector 1764 is a write head that can write the email onto the storage medium in the UMM 1710.

A HDD 1730, in which the HDD agent application 1732 resides, has a CPU 1766, a memory device 1768, a sensor 1770 and an effector 1772. The sensor 1770, in the present example, is adapted to sense availability of storage capacity in the HDD 1730. The effector 1772 is a write head that can write the email onto the storage medium in the HDD 1730.

The memory devices 1744, 1752, 1760 and 1768 typically comprise a mixture of ROM and RAM memory elements, and operate in concert with their respective CPUs 1742, 1750, 1758 and 1766 in a manner consistent with that previously described with reference to FIG. 3.

The agents 1714-1718 and 1732, in this arrangement, run on respective CPUs 1742, 1750, 1758 and 1766, on the respective appliances, namely the DTV 1706, the printer 1708, the UMM 1710 and the HDD 1730. The PC 1702, the DTV 1706, the Printer 1708, the UMM 1710 and the HDD 1730 are connected to the network 1720 by means of connections 1722, 1724, 1726, 1728 and 1734 respectively.

Communication channels between the agents 1714-1718, and 1732 are preferably implemented by TCP/IP socket connections (hereinafter “sockets”) as described in relation to FIG. 7. The IAS application 1704 is started first, and establishes a “listening” socket to receive messages from the agents 1714-1718 and 1732. The sockets are established by the respective CPUs 1736, 1742, 1750, 1758 and 1766, using associated memory devices 1738, 1744, 1752, 1760 and 1768 as required. The agents 1714-1718 and 1732 are then started (in any order), each agent creating respective sockets for use in (i) communication with the IAS 1704 and, via the IAS 1704, (ii) with other agents, as well as for (iii) establishing contact with the IAS 1704, and (iv) registering with the IAS 1704.

In a first arrangement, a Personal Computer Agent PCA 1774 classifies incoming emails by sender into one of N categories. The emails originate from a device/devices (not shown) which are attached to the network 1720 and which are accordingly able to communicate with the PC 1702 via suitable interface (not shown) in the PC 1702.

The email categories in the present arrangement comprise unique names for (i) each of the users friends (eg “Sam”, “Pete”, etc.), (ii) each of the users business acquaintances (eg “Mr Jones”, “Mrs Smith”, etc.), and (iii) a Miscellaneous category. The PCA 1774 determines, for each email category, whether upon logging on to the computer and accessing the email application, a user reads an associated email during the session in which the email first appears, or alternately defers opening the email to a later time. The PCA 1774 performs, in other words, an ongoing data analysis of user behaviour in regard to emails based upon their email category. Based upon this data, the PCA 1774 ascribes a probability measure to each email category. The probability measure is an indicator of the priority that the user effectively places upon a category. Thus, a 70% probability measure against “Sam” indicates that the user is likely to read an email from Sam immediately upon receipt, or at least, in the logon session during which the email appears. In contrast, a 10% measure against Mr. Jones indicates that the user will probably defer reading the email to another time.

The user agent 1712 develops the user profile using these probability measures, and uses the resultant profile to decide whether to notify the user about an incoming email while the user is watching the previously described soccer match on the DTV 1706. Thus, in the present arrangement, the user agent 1712 places a pop-up announcement on the screen of the DTV 1706 for incoming emails in categories with probability measures of greater than 50%. The 50% probability threshold may need to be manually programmed based upon empirically derived results from consumer satisfaction surveys that are conducted to assess the effectiveness of the system. This pop-up announcement is communicated from the CPU 1736 of the PC 1702 to the CPU 1742 of the DTV 1706, using the connections 1722 and 1724 and the network 1720.

In regard to email categories with a probability measure of less than 50%, however, the user agent 1712 does not interrupt the user while the user is watching the DTV 1706. Instead, the user agent 1712 sends a message from the CPU 1736 via the connection 1722, the network 1720 and the connection 1726 to the CPU 1750 of the printer 1708, this message being received and processed by the printer agent 1716. This message indicates that the incoming email should be printed on the printer 1708. Having passed the aforementioned message to the printer agent 1716, the user agent 1712 terminates its attention to the email, since control in regard to the email has been “handed over” or “propagated” to the printer agent 1716, which deals with this event (ie the email in question) in an autonomous fashion. Once control over the email has been handed over to the printer agent 1716, the DTV 1706 is no longer involved in dealing with email. Accordingly, the various hardware elements of the DTV 1706, namely the CPU 1742, and the memory device 1744 are not required in regard to further processing of the email.

Since control has been handed over to the printer agent 1716, the agent 1716 will attempt, in the first instance, to print out the email message on the printer 1708. If, however, the sensor 1754 on the printer 1708 signals to the printer CPU 1750 that the printer 1708 has run out of paper, then the printer agent 1716 sends a message, using a communication channel established between the printer CPU 1750 and the HDD CPU 1766 via the network 1720 indicating that the HDD 1730 should store the incoming email on the HDD hard disk. If the printer 1708 has run out of paper, then the effector 1756 (ie. the print head) of the printer 1708 operates to then print out the email as desired.

Once the printer agent 1716 has passed the aforementioned messages to the HDD agent 1732, the printer agent 1716 pays no further attention to that particular email, having handed over control regarding the email to the HDD agent 1732.

The HDD agent 1732 will control the HDD 1730 using the HDD CPU 1766 to store the aforementioned mail using the effector 1772 (ie the HDD write head) to store the email to an appropriate memory medium. In the event, however, that the HDD sensor 1770 signals to the HDD CPU 1766 that the HDD 1730 has insufficient storage space to store the email, then the HDD agent 1732 can, since there is another suitable appliance connected to the network 1720 (ie the UMM 1710), send a message to that appliance and hand over control of the issue thereto, and so on.

In summary, each appliance agent 1714-1718 and 1732 is able to either deal with the email in its own associated appliance 1706-1710 and 1730, or alternatively, can hand the matter over to another appliance agent for processing. In the present arrangement, the respective sensors 1746, 1754, 1762 and 1770 communicate with the respective CPUs 1742, 1750 and 1758 and 1766 of the respective appliances (ie the DTV 1706, the printer 1708, the UMM 1710 and the HDD 1730 ) as to whether the respective appliances are able to perform the desired action. The desired action, in the present example, is to process the email in a manner which is useful to the user. If an appliance is able to process the email, then the respective effector takes then necessary action. Thus, for example, the effector 1748 of the DTV 1706 operates to display the email on the screen. The effector 1756 of the printer 1708 operates to print the email. The effector 1764 of the UMM 1710 operates to store the email, and the effector 1772 of the HDD 1730 operates to store the email.

In the event that a handover from one appliance to another appliance is necessary, then the agent which is handing over control of the email to another agent is able to forget about the email once the control has been handed over. This leaves the recipient agent to handle the matter in an autonomous fashion. This distributed mode of control provides advantageous performance in that no central control is necessary, thereby providing the ability to add additional agents and their associated appliances without having to reconfigure a central controller. Furthermore, any particular agent appliance is able to address a particular task either by dealing with the task directly, or alternatively, by handing the task over to another appliance agent, or back to the user agent, and thereafter is able to ignore the task.

Although the arrangement shown in FIG. 4 locates the agents physically with their respective appliances, other arrangements can also be used. Thus, for example, the appliance agents 1714-1718 and 1732 can all be implemented as applications running on the CPU 1736 on the PC 1702. In such an arrangement the respective appliances 1706-1710 and 1730 are still provided with respective CPUs 1742, 1750, 1758 and 1766 as well as respective memory devices 1744, 1752 and 1760 and 1768.

In such an arrangement, the CPUs and their associated memory devices are used by the respective appliance 1706-1710 and 1730 to process sensory inputs via the sensors 1746, 1754, 1762 and 1770. The CPUs and memory devices also control respective effectors 1748, 1756, 1764 and 1772.

The above arrangement may require manual programming to define the probability thresholds associated with the email categories. Another arrangement in which the agents have more “intelligence” is described in relation to FIGS. 11-16.

Returning to FIG. 2, in another arrangement, if the user 236 is not watching the DTV 202, and one of the user's favourite programs is presently showing, the user agent 230 can direct the VCR agent 228 to direct the VCR 208 to record the program. The user agent 230 can later direct the DTV agent 222 to offer the program via a pop-up announcement on the DTV 202 when the user 236 next switches on the DTV 202.

In an alternative control example, when the user agent 230 wants to print an image from the DTV 202 to the printer 206, the user agent 230 instructs the corresponding printer and DTV agents 226 and 222 respectively, who then perform the printing operation. Once the user agent has provided the necessary commands to the appliances to carry out the necessary function, the user agent does not take any further part in the process.

Although a specific example of the architecture is described, in which the inter-agent server 220 and the various agents 224-228, 230-234 reside on the DTV platform 214, these entities can reside on a variety of different platforms including home PC/Server, Set Top Box etc, and modification of most of the peripheral appliances is not required. The control messages from the appliance agents (222-228) to the peripheral appliances (202-208) may use standard appliance interface (eg., IEEE 1394 AV/C).

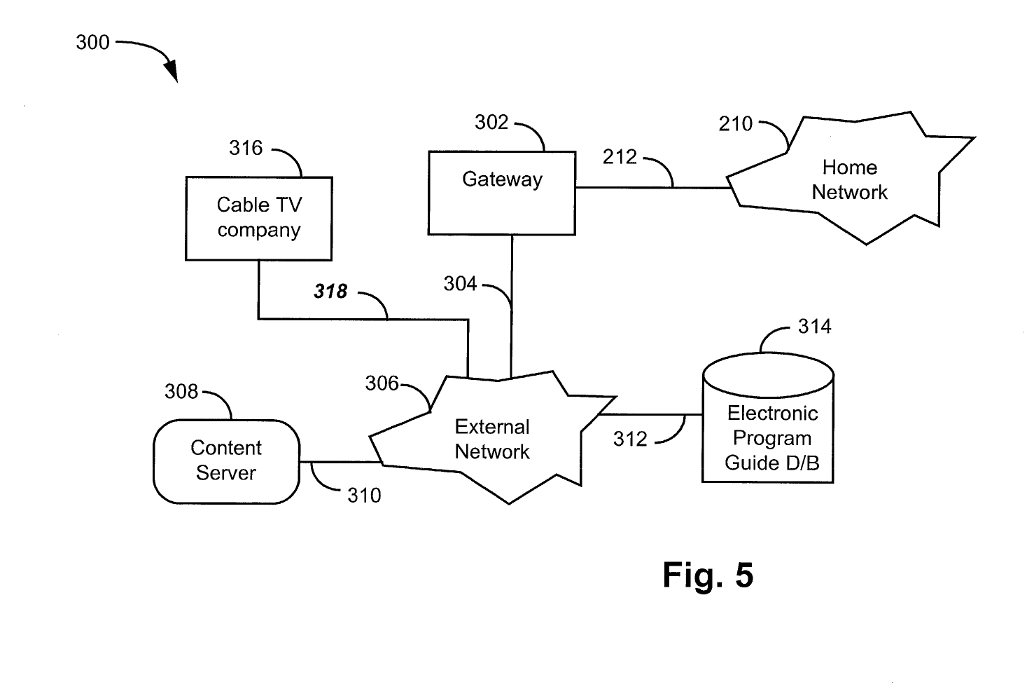

FIG. 5 shows an expanded system 300 in which the home network 210 (see FIG. 2) can be connected, as depicted by a line 212, to a gateway 302 which provides access to a broader environment. This broader environment comprises an external network 306 connected by a connection 304 to the gateway 302. A content server 308 is connected to the external network 306, as is an electronic program guide (EPG) 314, these being connected to the external network 306 by connections 310 and 312 respectively. The user agent 230 (see FIG. 2) is able to access and browse the EPG, and consequently can use information so gathered to plan a list of programs to be recorded by the VCR 208. The recording is performed in collaboration with the VCR agent 228. The content server 308 channels audio-visual content from individual content providers such as cable TV company 316, to an appliance (eg DTV 202, or VCR 208) for display or recording. The EPG 314 provides at least basic programming information, such as content provider identification, starting time and duration of programs, as requested by a user agent 230-234.

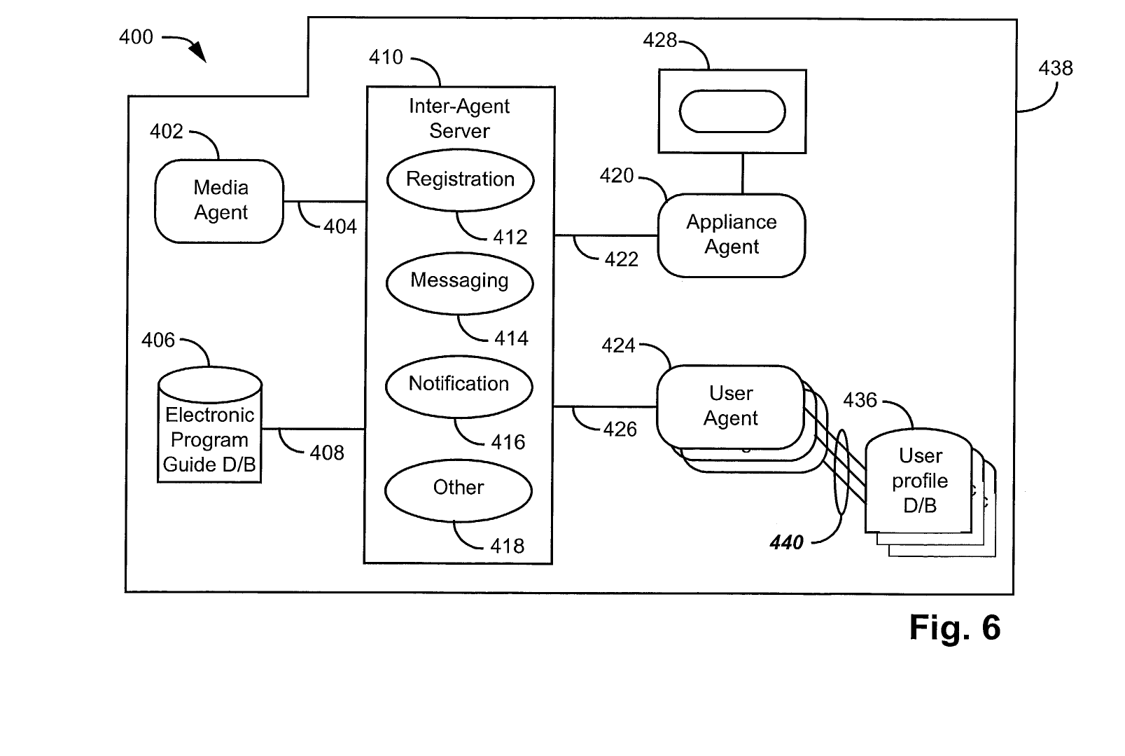

FIG. 6 shows an architectural block representation 400 of the intelligent platform 438. A media agent 402 and electronic program guide database 406 are connected to an inter-agent server 410 by connections 404 and 408 respectively. The media agent 402 analyses media (eg television, radio, information on the Internet) in terms of various features, and advises the relevant user agent about characteristic media items judged to be of importance. Although FIG. 6 depicts the EPG 406 as being integral to the platform 438, the EPG 406 can equally reside on another platform accessible across a network (eg. see FIG. 5).

An appliance agent 420 and a plurality of user agents 424 are connected to the inter-agent server 410 by connections 422 and 426 respectively. The appliance agent 420 is provided with a display 428. The user agents 424 are connected to a corresponding plurality of user profile databases 436 by a set of connections 440.

The inter-agent server 410 supports a number of internal processes including a registration process 412, a messaging process 414, a notification process 416, and other miscellaneous functionalities depicted by an oval 418. The registration process 412 deals with registration and de-registration of agents in regard to the IAS 410. The messaging function 414 supports inter-agent communication. The notification function 416 allows a user agent to interrogate status of various appliances, via their associated appliance agents, across the network.

The IAS 410 in the agent system provides the functions typical of a server in standard client-server models. An advantage of such models is that they are easily scaled, in that the number of communication channels increases only in proportion to the number of agents. These client-server models also permit common administrative tasks to be performed at a single location, usually at the server. In the following description, the IAS is also considered to be an agent, and general references to agents are also directed to the IAS.

In FIG. 7, a particular implementation 500 of an IAS 512 is shown. The IAS 512 and the agents 502, 526 and 528 are each representative of a respective process. The agent processes may all reside on a single computer, or alternately, may be distributed across a number of interconnected computers. The IAS 512 maintains two TCP/IP connections (referred to as “sockets”) to each of the other agents. These connections are depicted in FIG. 7 as pairs of bilateral arrows, eg 506 and 504. There are two sockets per agent in this implementation to promote autonomy amongst the agents, namely (i) a simple socket (depicted as a dashed bilateral arrow) through which agents can send messages asynchronously to the IAS or, via the IAS to other agents, and (ii) a reliable socket (depicted as a solid bilateral arrow) which is used for transmitting messages synchronously between agents when one agent expects an immediate reply to a message it has sent.

Accordingly, an agent 502 is connected to the IAS 512 using a simple socket 506 and a reliable socket 504. An agent 526 is connected to the IAS 512 using a simple socket 524 and a reliable socket 514. An agent 528 is connected to the IAS 512 using a simple socket 520 and a reliable socket 522.

The IAS 512 has a number of threads depicted by circles 510, 508, 516 and 518. The thread 508 listens to the simple socket 506. The thread 516 listens to the simple socket 524. The thread 518 listens to the simple socket 520. The thread 508 listens for new connections.

There are three phases in the life of an agent process and its communications with other agents, namely the startup phase, the communications phase, and the shutdown phase.

During the startup phase, the IAS 512 is the first process started. As subsequent processes are started, they each establish two socket connections to the IAS 512. The IAS 512 then performs the following tasks in regard to each specific agent:

the specific agent is “registered” as having established communications, and relevant information about the specific agent is recorded by the IAS 512;

a new process thread is started, which is responsible for “listening” for any messages that the specific agent sends on its simple socket;

all agents which have already registered with the IAS 512 are informed about the newly registered specific agent.

Because all inter-agent communications pass through the IAS 512, the IAS 512 retains a record of all agents present on the system in order to transmit messages to the correct agent or agents, and undertakes appropriate error correction if attempts are made to communicate to a non-existent agent.

In considering the communications phase, it is noted that in general, the IAS 512 is not concerned with the content of messages, only with ensuring that messages are passed correctly to the intended agents.

Whenever a message is received by one of the listening threads, it is examined by the IAS 512 to establish whether the initiating agent expects a reply (this being referred to as a “reliable message”) and, whether the intended recipient exists.

If the message is a “simple”, as distinct from a “reliable” message (a simple message is not expected to elicit a reply to the initiating agent), and the target agent exists, the message is forwarded to that agent through its simple socket.

If the message is a reliable message and the target exists, the message is forwarded to that agent through its reliable socket, and the IAS 512 waits for a reply on that socket. When the reply is received it is returned to the initiating agent through its reliable socket (which should be waiting for a reply through that socket).

If the IAS 512 fails to successfully forward a message because a socket connection has failed, the IAS 512 assumes that the corresponding agent has left the system 500 without de-registering.

Under normal circumstances, during the communication phase there is one special message which is handled differently by the IAS 512. This is described in the following section which relates to the shutdown phase. When an agent is about to shut down, it first reports the intention to do so to the IAS 512 using the aforementioned special message. The IAS 512 consequently removes that agent from the list of registered agents, and informs all other registered agents that the de-registered agent is no longer available. The special message is different to other messages received by the IAS 512 from agents during the communication phase, because the intended recipient of the special message is the IAS 512 itself. The special message is not transmitted to any other agent. The IAS 512 does, however, pass messages to registered agents informing them of the de-registration.

FIG. 8 depicts a first process 800 comprising a sequence of method steps by which an appliance agent and a user agent collaborate in order to control an appliance. The collaboration relates to building and updating a user profile, and may also involve optimising a cost function which is indicative of a level of satisfaction of a user. The user satisfaction relates to perception of the user concerning operation of an appliance that is associated with the appliance agent.

In a first step 802 the user agent monitors user behaviour in relation to the particular appliance. The appliance agent is the conduit through which user behaviour in regard to the appliance is monitored. In a following step 804, the user agent updates a user profile, based on the aforementioned monitored behaviour. Thereafter, in a step 806, the user agent provides a direction, based on the profile, to the appliance agent.

In a following step 808, the appliance agent performs control and/or sensing functions in order to control and/or monitor the appliance, thereby sensing user interaction therewith, and feeding information in this regard back to the user agent. The feedback is depicted by a dashed line 810. The iterative process 800 may improve a cost function which is indicative of a satisfaction level of the user relating to operation of the appliance. In functional terms, the user agent and appliance agent collaborate, using sensed behavioural information from the user's interaction with the appliance, to optimise use of the appliance by the user, thereby maximising the user's satisfaction with the performance of the particular appliance.

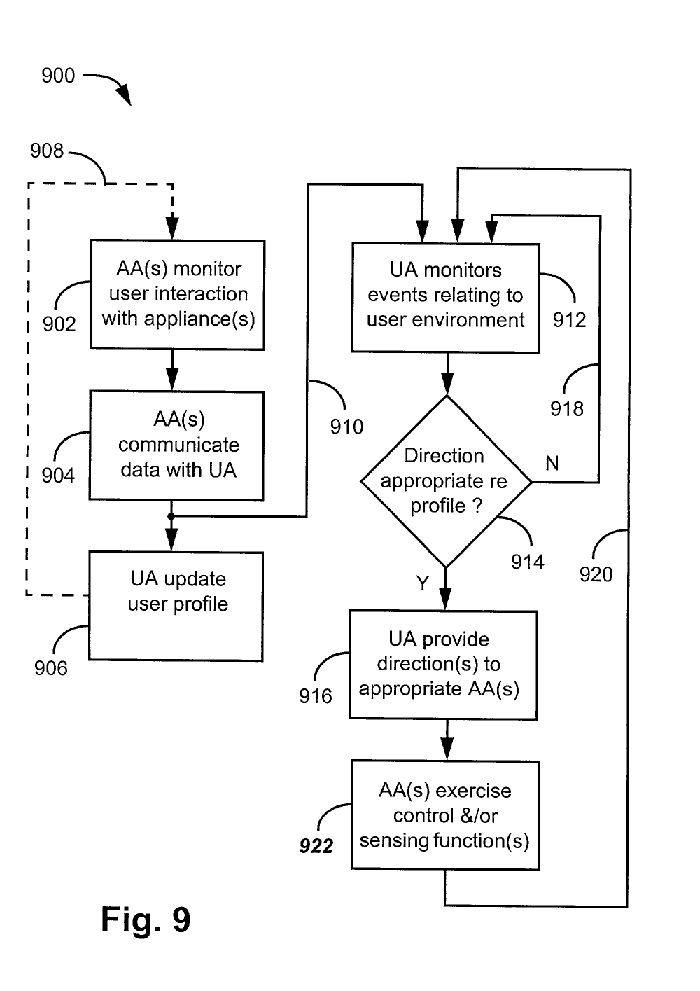

FIG. 9 shows a second process 900 depicted as a sequence of method steps which control an appliance in the system of FIG. 1. In a first step 902 one or more appliance agents monitor user interactions with one or more associated appliances, thereafter communicating, in a step 904, data dependent upon the interaction(s) to a user agent associated with the user. In a following step 906, the user agent updates a user profile in accordance with the communicated data. Thereafter, the process 900 is directed back to the monitoring step 902 as depicted by a dashed arrow 908.

The step 904 is also followed, as depicted by an arrow 910, by a step 912 that depicts the user agent monitoring events relating to the user environment. In the present example, the events are manifested by the data communicated between the appliance agents and the user agent in the step 904. In a decision step 914, the user agent makes a decision, based upon the communicated data from the step 904, and also upon the user profile.

If a criterion based upon the two aforementioned factors is satisfied, then the process 900 proceeds to a step 916 which causes one or more directions to be issued to the one or more appliance agents. This causes, in a step 922, the appliance agents to exercise control and/or sensing functions in relation to their associated appliances in accordance with the direction(s). The process 900 is then directed, in accordance with an arrow 920, from the step 922 to the step 912. If the criterion in the step 914 is not satisfied, then the process 900 is directed from the decision step 914 to the step 912 in accordance with an arrow 918.

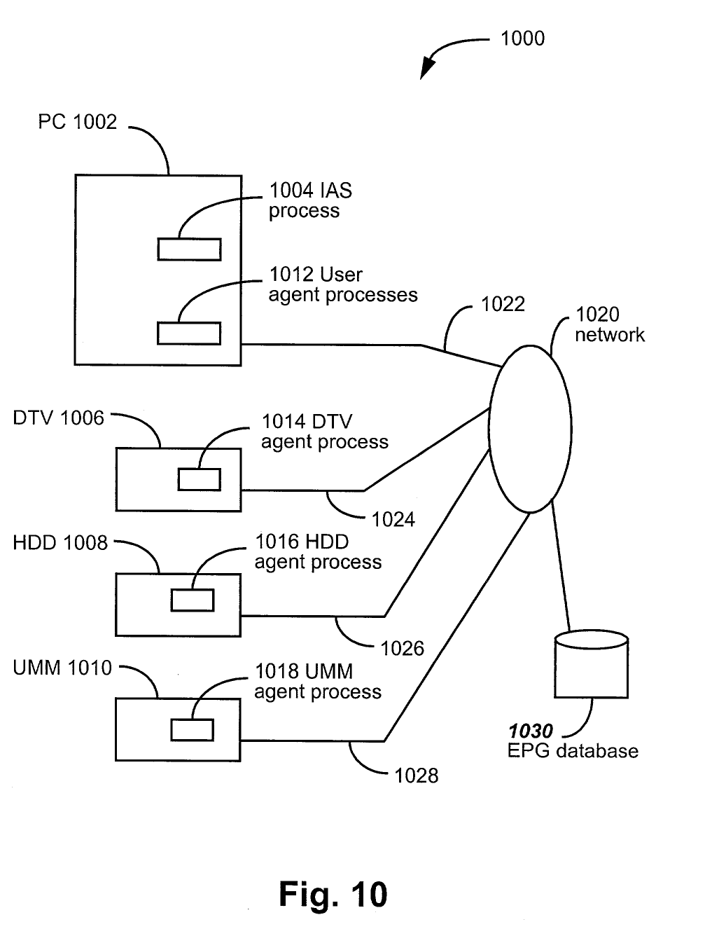

FIG. 10 shows a further exemplary implementation 1000 of a multi-agent system. An Inter-Agent Server (IAS) is implemented by means of a process 1004 on a PC 1002. A second process 1012 represents user agents. Which particular user agent is represented at any given time is described below. In addition to the two processes 1004 and 1012, there are further processes for each of three appliance agents, namely a DTV agent 1014, an HDD agent 1016 (which is the agent for a storage medium, such as a Hard-Disk Drive, referred to as an HDD) and a UMM agent 1018 (which is the agent for a Unified Messaging Module, which can receive and store communications, such as electronic mail or facsimile transmissions respectively). The terms “agent” and “agent process” are used interchangeably, the specific usage intended being clear from the context unless made otherwise explicit. The agents 1014-1018 reside on the respective appliances namely a DTV 1006, an HDD 1008, and a UMM 1010 respectively. It is noted that the PC 1002, the DTV 1006, the HDD 1008, and the UMM 1010 are connected to the network 1020 by means of connections 1022, 1024, 1026 and 1028 respectively. Furthermore, an Electronic Program Guide (EPG) database 1030 is also connected to the network 1020.

Communication channels between the agents are TCP/IP sockets as described in relation to FIG. 7. The IAS 1004 is started first, and establishes a “listening” socket to receive messages from the agents 1014-1018. The agents 1014-1018 are then started (in any order), each agent creating respective sockets for use in (i) communication with the IAS 1004, and via the IAS 1004, (ii) with other agents, as well as for (iii) establishing contact with the IAS 1004, and (iv) registering with the IAS 1004.

All user interaction with the agents 1012-1018 takes place through the DTV 1006 and the associated DTV agent process 1014. The DTV agent 1014 can prompt the user for specific information, as well as monitor the user's use of the DTV 1006. The information collected in this way is sent to the user agent 1012.

FIG. 11 shows a block diagram representation of databases and files stored therein which are used by a user agent. This provides background and terminology which is necessary to understand the operation of the learning, reasoning and planning modules which are to be described. In FIG. 11, a user agent 1502 is connected to a user profile file database 1504, and an “instance” file database 1510. The term “user profile” typically includes reference to records in either, or both, the user profile file database 1504, and the “instance” file database 1510. The user profile file database 1504 contains, as depicted by a dashed line 1506, a record 1508 of entries describing DTV program selections made by the user. The record 1508 is seen to comprise a number of program selections depicted as “program selection #1”, . . . , “program selection #n”. A particular entry may comprise, for example, the following information:

Category=‘drama’;

Sub-category=‘comedy/drama’;

Channel=10;

Time=1800

Day=Wednesday

The instance files database 1510 comprises records 1514 of actions taken by the user relating to DTV functionality. Such functionality is defined by the particular DTV (eg. see FIG. 10 with respect to DTV 1006). The record 1514 of actions taken by the user is seen to comprise a number of entries, namely “action#1”, . . . “action#m”. The aforementioned decisions (or actions) can belong, as depicted by an arrow 1516, to a set 1518 of different categories of action. One such action 1520 is a “UMM content display” instance file 1520, which has entries describing actions taken by the user which relate to displaying a message from the UMM 1010 (see FIG. 10). The particular message (eg. “UMM message display #1” in the instance file 1520) may include details such as (i) the category of the DTV content that the user was watching when the message came in, (ii) the type of message (eg. e-mail, voicemail etc), (iii) priority of the message, (iv) day of the week, (v) time and decision taken by the user as a result of receiving the message etc. The particular decision taken by the user could, for example, include the following:

ask for confirmation

open a small secondary display window on the DTV screen to display the message

open a medium secondary window

open a large secondary window

do not interrupt.

Similar entries are created for a “HDD partial playback” instance file 1522, this relating to parts of programs recorded by the HDD 1008 (see FIG. 10) and offered at some later time to the user for possible viewing. An “HDD full content playback” instance file 1524 is also shown, this relating to complete programs recorded on the HDD 1008 (see FIG. 10) and offered it to the user for watching at some later stage.

In the exemplary arrangement, there are three types of operation, corresponding to three processes that the user agent 1012 performs. The aforementioned three processes can take place in any sequence. The three types of operation are learning, reasoning and planning.

Learning.

Returning to FIG. 10, whenever the user makes a selection via the DTV 1006 (eg choosing to watch a program, choosing to record a program, switching the appliance on or off), the DTV agent 1014 informs the user agent 1012 of the selection, and supplies corresponding data related to the selection. This data can include the kind of program being watched, the associated program provider, and other relevant current information about the user. The user agent 1012 can tabulate, or otherwise manipulate, this information to construct the user profile that is maintained by the user agent 1012.

The user agent 1012 may require additional information, and can request that the DTV agent 1014 acquire such information by prompting the user. In addition, the user agent 1012 can query an EPG database 1030 for further information about the program.

When the user profile is first constructed, the user agent 1012 has no information about the “new” user. In order to initialise the user profile, the agent 1012 may ask the DTV agent 1014 to collect information from the user for this purpose. This information might be the type of personal information that could be used to establish how the user might be represented by some demographic “average”, or it might be information about a user's favourite (or commonly watched) programs, which can also be used to build an approximate model of the user's viewing habits.

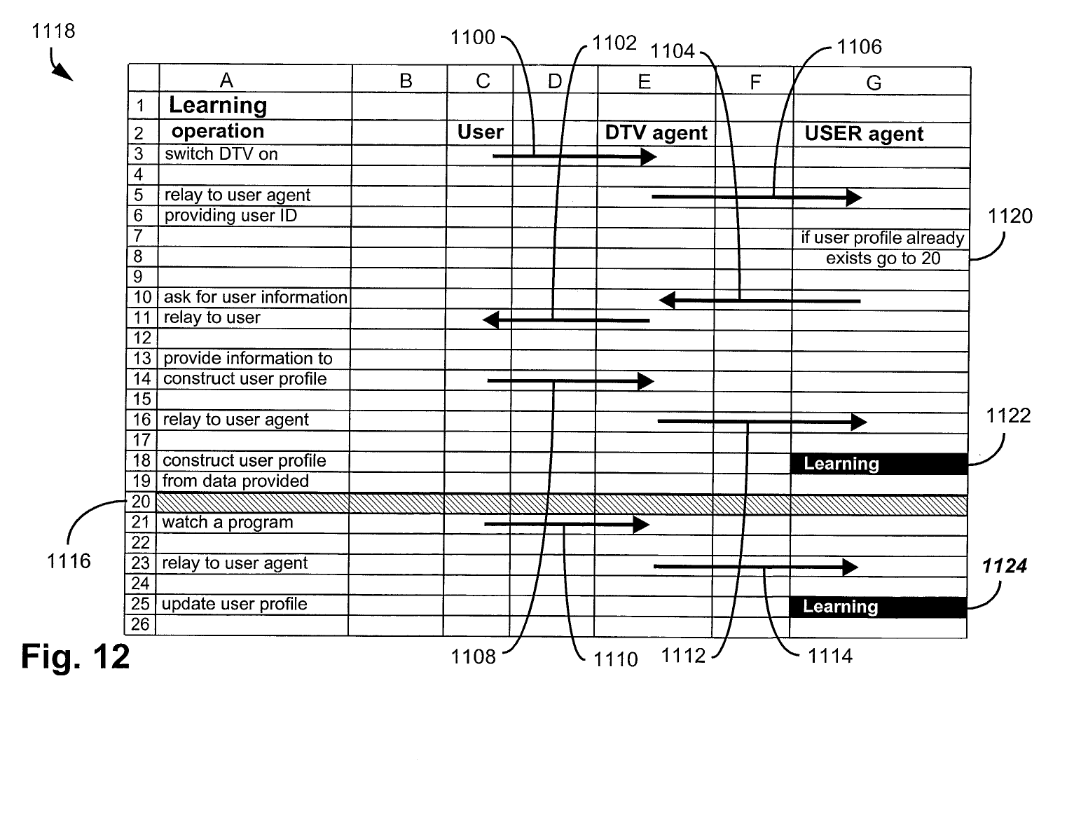

FIG. 12 shows a learning process 1118, with a typical sequence of messages passed between the user, the DTV agent 1014, and the user agent 1012 (see FIG. 10). The learning process 1118 also includes a learning “activity” depicted by shaded cells 1122 and 1124. To simplify the diagram, the IAS 1004 has been omitted from the message passing sequence. All messages between agents are mediated by the IAS 1004. FIG. 12 shows a process flow diagram in the form of a matrix representation having seven columns “A” to “G”, and 26 lines numbered “1” to “26”. Having regard to line 2 of the matrix, it is noted that column C makes reference to a “user”, column E makes reference to the “DTV agent” 1014 (see FIG. 10) and column G makes reference to the “user agent” 1012 (see FIG. 10). In this exemplary learning process, in a first step on line 3 the user switches on the DTV, this eliciting a message from the user to the DTV agent 1014 as depicted by an arrow 1100. Thereafter, as shown on lines 5 and 6, the DTV agent 1014 sends a message to the user agent 1012 as depicted by an arrow 1106. Thereafter, as shown on lines 7 and 8 in column “G” if a user profile already exists, the process 1118 is directed to line 20 (designated by a reference number 1116). If the user profile does already exist, then the process 1118 is directed to line 10 of the matrix, in which the user agent 1012 asks the user (via the DTV agent 1014) for information, this being depicted by an arrow 1104. Thereafter, as shown on line 11, the DTV agent 1014 relays the aforementioned information to the user, as depicted by an arrow 1102.

Thereafter, the user provides information to the DTV agent 1014, as depicted by an arrow 1108, this provision of information to be used for construction of the user profile. Subsequently, as shown on line 16, the DTV agent 1014 relays the aforementioned information to the user agent 1012, this being depicted by an arrow 1112.

Thereafter, as shown on lines 18 and 19 in column A of the matrix, the user agent 1012 constructs the user profile from the data provided, this construction being depicted by a shaded matrix cell 1122 labelled “learning”. Thereafter, as shown on line 21, the user watches a program, this being noted by the DTV agent 1014 as depicted by an arrow 1110. Line 23 shows how the aforementioned information (ie. the fact that the user is watching the program) is relayed by the DTV agent 1014 to the user agent 1012, as depicted by an arrow 1114. Thereafter, as shown on line 25, the user agent 1012 updates the user profile, this being depicted by a shaded cell 1124 labelled “learning”. It is noted that lines 3 to 19 represent an initial learning stage, whereas lines 21 to 25 represent an “updating” learning stage. The learning activities 1122 and 1124 are described in relation to FIGS. 11 and 16.

Reasoning.

Reasoning refers to the user agent's use of the user profile in order to make a choice in response to a user's request. For instance, the user may switch on the DTV 1006 (see FIG. 10), and may want his or her associated user agent (1012) to use the information contained in the user profile (not shown), and knowledge of the current context (such as the programs that are actually available to watch) to suggest a subset of the available programs that the user is likely to be interested in watching.

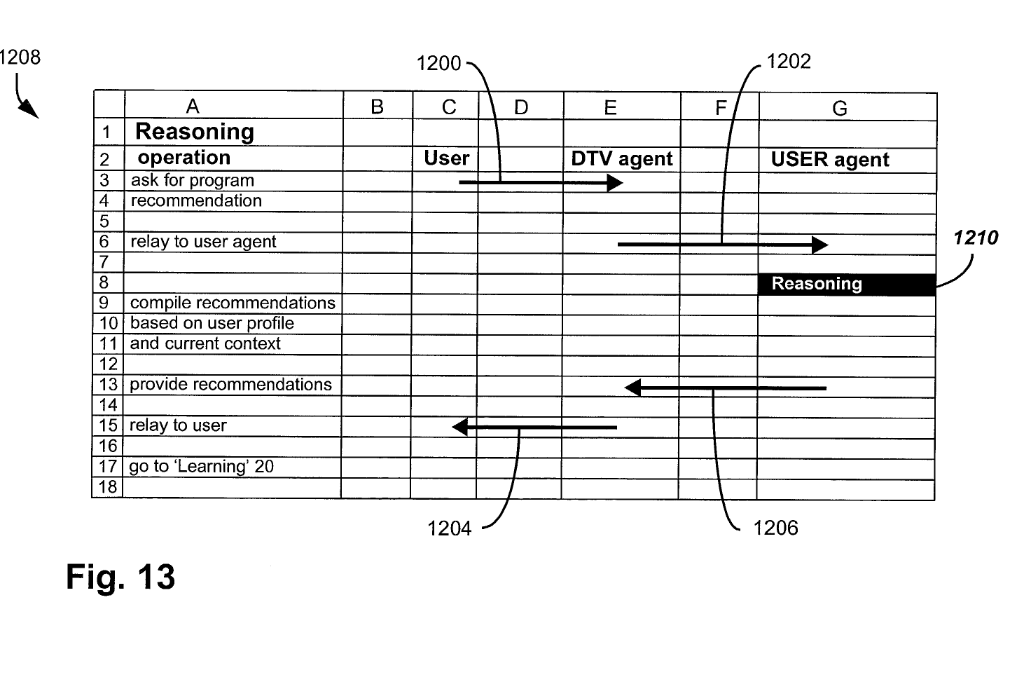

FIG. 13 shows a reasoning process 1208 comprising a typical sequence of messages passed between the user, the DTV agent 1014, and the user agent 1012. The reasoning process 1208 also includes a reasoning “activity” depicted by a shaded cell 1210. When the user selects a program to watch, this information is passed to the user agent 1012, which incorporates the new information into the user profile using an appropriate learning algorithm (see FIG. 12). In FIG. 13, the reasoning process 1208 is shown in the form of a matrix having seven columns labelled “A” to “G”, and eighteen lines, numbered 1 to 18. On line 3, the user requests a program recommendation, this request being communicated to the DTV agent 1014, as depicted by an arrow 1200. As shown on line 6, the DTV agent 1014 relays the aforementioned request to the user agent 1012, this being depicted by an arrow 1202. Thereafter, the user agent 1012 performs a reasoning activity as shown by a shaded cell 1210. The reasoning activity is described in relation to FIGS. 11 and 16. The aforementioned reasoning activity 1210 results in compilation of recommendations based on the user profile and the current context, this being shown by lines 9 to 11 of the matrix representation 1208. Thereafter, as shown by line 13, the user agent 1012 provides the aforementioned compiled recommendations to the DTV agent 1014, as depicted by an arrow 1206. Subsequently, the DTV agent 1014 relays these recommendations to the user, as depicted by an arrow 1204. In a subsequent line 17, the reasoning process 1208 is directed to the learning process 1118 (see FIG. 12) on line 20, which is depicted by a reference numeral 1116.

Planning.

Planning refers to the use by the user agent 1012 of the user profile in order to make a decision in response to events not initiated by the user. For instance, if an e-mail communication is received by the UMM agent 1010 (see FIG. 10), the user agent 1012 can make decisions (using the user profile) about whether (and how) to display the communication. Accordingly, in the present example, the user agent 1012 must decide whether to request the HDD agent 1016 to record the program that is being watched by the user, and whether (and how) to display the recorded section of the program after the user has finished reading the e-mail.

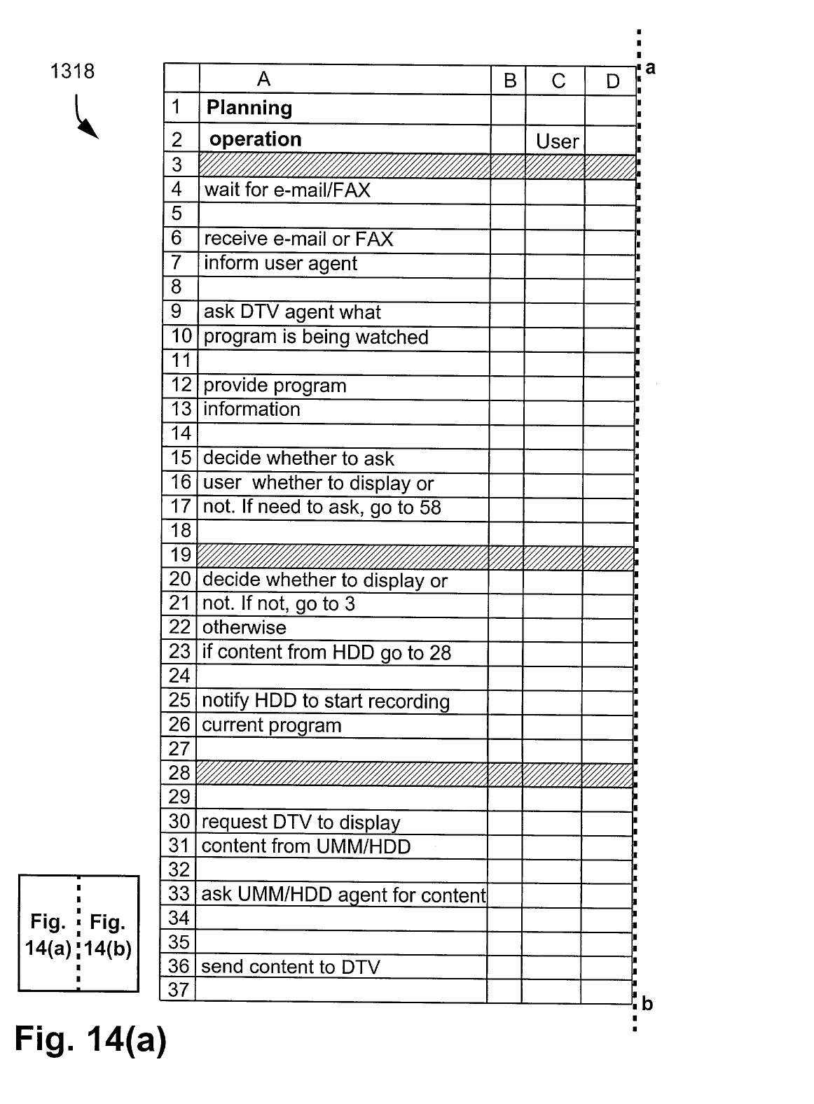

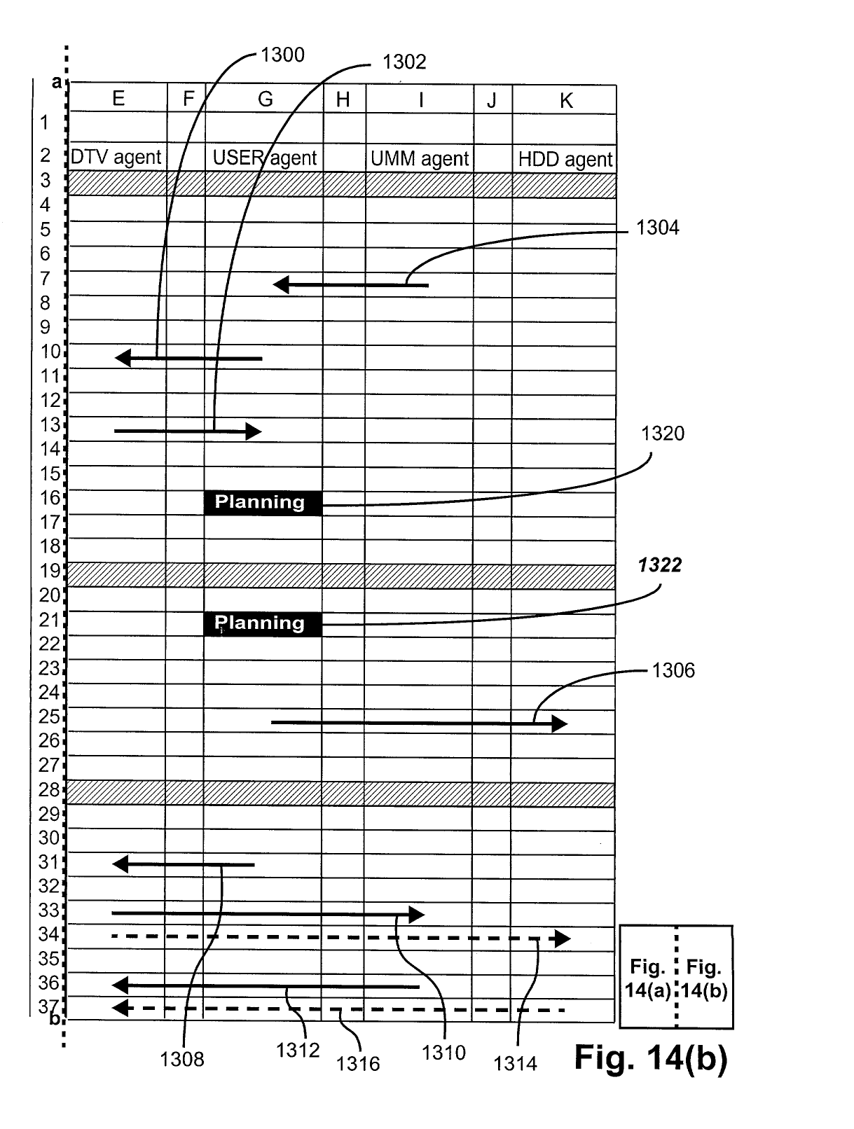

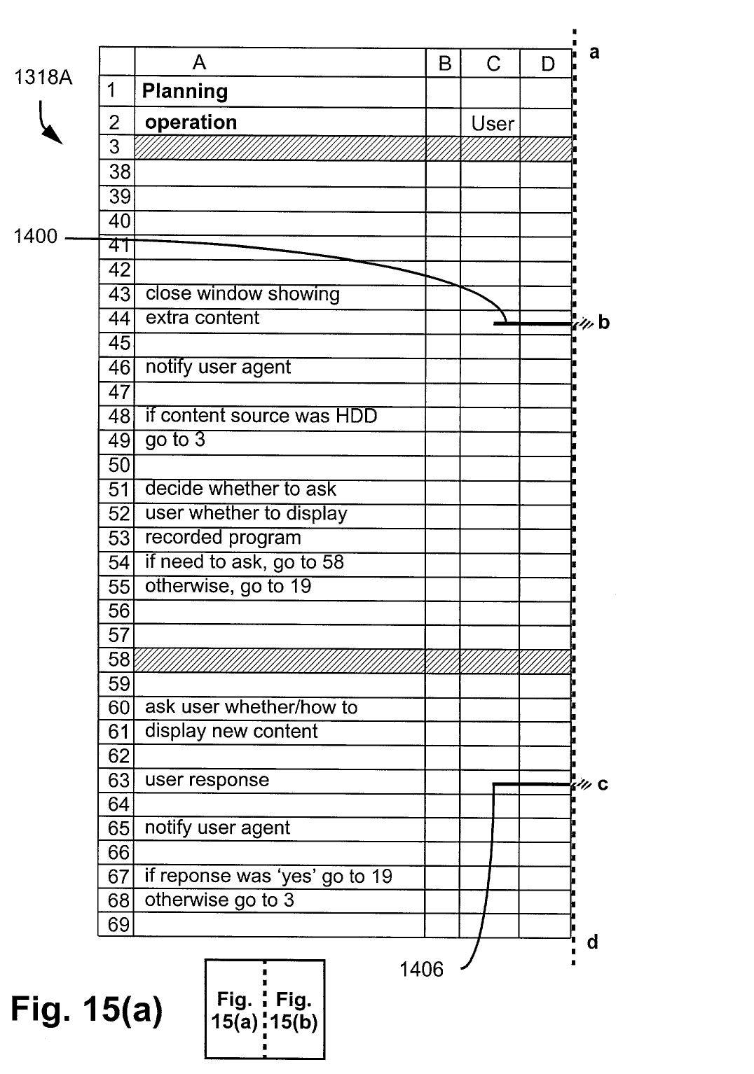

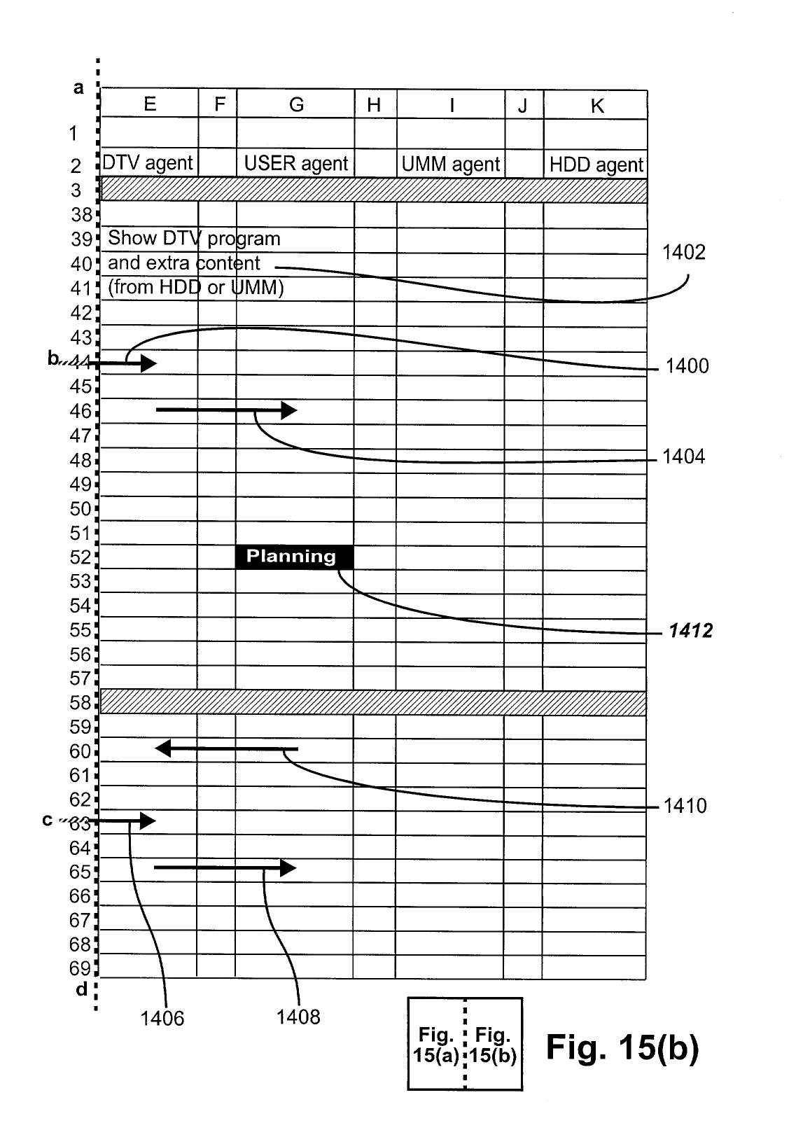

FIGS. 14 and 15 show exemplary planning process segments 1318 and 1318A comprising typical sequences of messages between the user, the DTV agent 1014, the user agent 1012, the UMM agent 1018 and the HDD agent 1008. The planning process segments 1318 and 1318A also include planning “activities” depicted by shaded cells 1320, 1322 and 1412. These planning activities are described in relation to FIGS. 11 and 16. FIG. 14 shows a first segment 1318 of a planning process in the form of a matrix having eleven columns labelled “A” to “K”, and 37 lines labelled 1 to 37. The process segment 1318 involves participation by a number of entities namely the user (line 2 column C), the DTV agent 1014 (line 2 column E), the user agent 1012 (line 2 column G), the UMM agent 1018 (line 2 column I), and the HDD agent 1016 (line 2 column K). Initially, as shown on line 4, the planning process segment 1318 waits for an email or facsimile. Thereafter, as shown on lines 6 and 7, an email is received by the UMM agent 1018 which notifies the user agent 1012 as depicted by an arrow 1304.

Thereafter, as shown on lines 9 and 10, the user agent 1012 “asks” the DTV agent 1014 which program is currently being watched by the user, this request being depicted by an arrow 1300. In response, as shown on lines 12 and 13, the DTV agent 1014 provides appropriate program information to the user agent 1012, as depicted by an arrow 1302. Subsequently, as shown on lines 15 to 17, the user agent 1012 decides whether it does, or does not have sufficient information to decide whether to display the newly arrived email. If the user agent 1012, concludes, in the course of a planning activity depicted by a shaded cell 1320, that it needs to ask the user whether or not to display the email, the process segment 1318 is directed to line 58 (see FIG. 15). If, on the other hand, the user agent 1012, decides that user intervention is not required, then the process segment 1318 is directed to lines 20 and 21, where the user agent 1012 performs a further planning activity depicted by a shaded cell 1322.

If the user agent, as a result of the planning process 1322, decides not to display the content (eg. from the HDD or the UMM), the process segment 1318 is directed back to line 3. If the user agent 1012 decides, in the course of the planning activity 1322 to display the received information, then as shown on a line 23, if the content being watched has previously been stored on the HDD 1008, then the process segment 1318 is directed to line 28. If, on the other hand, the content presently being watched by the user has not been previously stored on the HDD 1008, then the process segment 1318 is directed to lines 25 and 26, which shows the user agent 1012 directing the HDD agent 1016 to commence recording the current program being watched, this being depicted by an arrow 1306.

Subsequent to the line 23, line 28 is “null” process step, and the planning process segment 1318 is directed to lines 30 and 31 in which the user agent 1012 directs the DTV agent 1014 to display content from the UMM 1010/HDD 1008, as shown by an arrow 1308. In a subsequent line 33, the DTV agent 1014 requests the UMM agent 1018, and, if necessary, the HDD agent 1016 for the content for display, this being shown by an arrow 1310, and a dashed arrow 1314 respectively. Subsequently, the UMM agent 1018 and, if appropriate, the HDD agent 1016 send the desired content to the DTV agent 1014, as depicted by an arrow 1312 and a dashed arrow 1316.

FIG. 15 shows a continuation process segment 1318A of the planning process segment 1318 shown FIG. 14. Lines 39 to 41 depict that the DTV agent 1014 shows the DTV program and the extra content (from the HDD 1008 and/or the UMM 1010) to the user. As shown at lines 43 and 44, the user subsequently closes the window showing the additional content, as depicted by an arrow 1400. Thereafter, as shown by line 46, the DTV agent 1014 notifies the user agent 1012 of the aforementioned user event (ie. the window closure), as depicted by an arrow 1404.

Turning to subsequent lines 48 and 49, if the content source was the HDD 1008, the process segment 1318A is directed to line 3 (see FIG. 14). Alternately, at lines 51 to 53, the user agent 1012 decides, using a planning activity 1412, whether to ask the user if the user wishes to display the recorded program. If the planning activity 1412 concludes that the user should be so asked, then the process segment 1318A is directed to a line 58. If the planning activity 1412 concludes that the user need not be asked, then the process segment 1318A is directed to line 19 (see FIG. 14).

Subsequent to the line 55, it is noted that the line 58 is a “null” process, and accordingly process segment 1318A is directed to a line 60, at which the user agent 1012 asks the DTV agent 1014 to convey a request to the user as to whether and, if so, how to display the new content, this being depicted by an arrow 1410. At line 63, the user makes an appropriate response to the DTV agent 1014, as depicted by an arrow 1406. Thereafter, at line 65, the DTV agent 1014 notifies the user agent 1012 of the user response, this being depicted by an arrow 1408. At line 67, if the user response (depicted by the arrow 1406) was “yes”, then the process segment 1318A is directed to line 19 (see FIG. 14). Alternately, the process segment 1318A is directed to line 3 (see FIG. 14). A summary description of the aforementioned planning example is as follows:

1. An e-mail arrives at the UMM. The UMM agent notifies the user agent.

2. The user agent asks the DTV agent what the user is currently watching.

3. The DTV agent provides information about the current program.

4. The user agent may not have enough information to decide whether to display the newly arrived e-mail. If that is the case, the DTV agent is requested by the user agent to ask the user whether to display the e-mail. The user says “yes”, and the DTV agent informs the user agent of this response.

5. The user agent asks the HDD agent to record the program being watched.

6. The user agent informs the DTV agent that it should ask for new content from the UMM.

7. The DTV agent asks the UMM agent to send the UMM content (i.e. the e-mail). When the e-mail is received, the content is displayed on the DTV.

8. When the user dismisses the e-mail display, the DTV agent tells the user agent of this user action.

9. The user agent may not have enough information to decide whether to display the recorded segment of program, If that is the case, the DTV agent is requested by the user agent to ask the user whether to display the recording. The user says “yes”, and the DTV agent so informs the user agent.

10. The user agent informs the DTV agent that it should ask for content from the HDD.

11. The DTV agent asks the HDD agent to send the HDD content (i.e. the recording). When the recording is received, the content is displayed on the DTV.

12. When the user dismisses the recorded program display, the DTV agent tells the user agent.

13. The planning sequence is ready to be restarted.

FIG. 16 shows a dataflow diagram 1600 depicting, in an exemplary agent architecture, how the profile selection records 1508 and the instance records 1518 (see FIG. 11) are used by a learning module 1602, a reasoning module 1618, and a planning module 1626. The learning module 1602 operates separately on the program selection file 1508, the UMM message display instance file 1520, the HDD partial playback instance file 1522, and the HDD full playback instance file 1524 as depicted by arrows 1604, 1606, 1608 and 1610 respectively. The learning module 1602 operates on these files to identify shared (ie generalisation) patterns 1614 of entries from the particular instance files. A generalisation pattern represents intersections between the various entries in the files, and the frequency with which these intersections occur. The learning module 1602 determines, as depicted by an arrow 1612, the generalisation patterns 1614 for use by the reasoning module 1618, and the planning module 1626.

The reasoning module 1618 uses, as depicted by an arrow 1616, the generalisation patterns 1614 in order to make, as depicted by an arrow 1620, recommendations 1622 to the user. These recommendations constitute, for the present example, the most suitable DTV viewer options available for the particular user. The reasoning module 1618 first orders the generalisation patterns 1614, this ordering sometimes including ordering the generalisation patterns in descending frequency of occurrence. Alternately, the ordering may be based upon descending specificity level, the specificity of a pattern being proportional to the number of intersections between various entries in the associated files. The reasoning module 1618 thereafter filters the ordered generalisation patterns. The filters (not shown) include a filter which verifies whether a generalisation pattern is time and day specific, and also verifies that the specific time and/or day corresponds with the time and/or day for which recommendations are currently being requested. Another filter may require that the occurrence of the generalisation pattern be above the average of occurrences for all generalisation patterns.

The effect of combining the filters and the aforementioned ordering process provides a number of “tasks”. Commencing with the task that has been most successful in the past, (ie. where the user has, in fact, accepted recommendations made), the task is applied to the generalisation pattern, and thereafter, commencing at the first entry of a resulting list, that particular entry is matched with entries from the EPG database 1030 (see FIG. 10). Entries which match corresponding entries in the EPG are then provided as recommendations to the user.

The planning module 1626 also makes use, as depicted by an arrow 1624, of the generalisation patterns 1614. Thus, for example, when an e-mail, as depicted by an arrow 1628, is received by the system 1600, the learning module 1602 finds the generalisation patterns in the UMM message display instance file 1520. Thereafter, behaviour patterns are extracted on the basis of entries in the generalisation patterns 1614 which contain planning decisions (ie. actions) as intersections. Thereafter, intersections between the present situation (as defined, for example, by a category of DTV content, a type of message, priority, day, time etc) and the behavioural patterns are found. Based upon the aforementioned intersections, and also upon the decision and frequency associated with the intersections, a “most appropriate” decision is determined by the planning module 1626 and applied, as depicted by an arrow 1630, to the current UMM content, this being the e-mail 1628. Thus, for example, the particular recommendation may be to store the e-mail in the HDD 1008 (see FIG. 10), or alternately, to open a minor window in the display of the DTV 1006 (see FIG. 10) for immediate display.

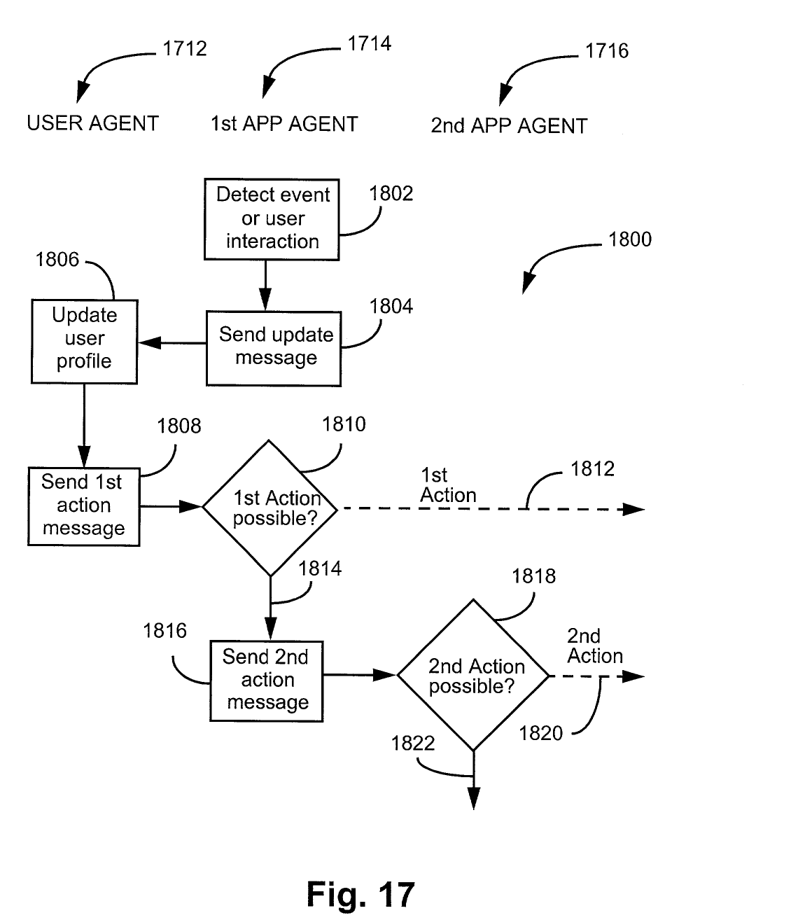

FIG. 17 shows an exemplary multi-agent process 1800 for controlling a number of the appliances in FIG. 4 using the disclosed distributed-control approach. FIG. 17 is segmented into three columns relating to the user agent 1712, the DTV agent 1714 (also referred to as the first agent), and the printer agent 1716 (also referred to as the second agent). The process 1800 commences at a step 1802 wherein the DTV agent 1714 detects an event, or a user interaction, with the DTV 1706 that is associated with the DTV agent 1714. One such event is arrival of an email as described in relation to FIG. 4. Thereafter, in a step 1804, the DTV agent 1714 sends an update message to the user agent 1712, whereafter the user agent 1712 updates the user profile in a step 1806. Thereafter, in a step 1808, the user agent 1712 sends a first action message in a step 1808 to the DTV agent 1714.

The DTV agent 1714 considers, in a decision step 1810, whether the first action is, in fact, possible for the DTV 1706 to perform. This decision may, for example, be made on the basis of whether the email category probability measure is greater than 50%. In the event that the decision step 1810 concludes that the first action is possible (ie. that the proability is greater than 50%), then the process 1800 is directed in accordance with a dashed arrow 1812, which depicts performance of the first action (ie. Display of the email on the screen of the DTV 1706). A dashed arrow is used to indicate that the process 1800 is directed to the DTV 1706 associated with the DTV agent 1714, where the DTV 1706 itself is not shown in FIG. 17.

If, in contrast, the decision step 1810 concludes that the first action (ie. display of the email on the screen of the DTV 1706) is not possible, then the process 1800 is directed in accordance with an arrow 1814 to a step 1816. In step 1816, the DTV agent 1714 generates and sends a second action message to the printer agent 1716. The printer agent 1716 considers, in a decision step 1818, and on the basis of a signal from the sensor 1754 to the CPU 1750 (see FIG. 4) whether the second action, associated with the second action message sent in the step 1816, is possible for the printer 1708 to perform. Thus the DTV agent 1714, realising that the particular email cannot be displayed on the DTV 1706 due to a low priority (ie. less than 50%), then operates to identify a suitable alternative appliance/agent pair, and sends a second action message to that appliance/agent pair to instruct printing of the following email, presuming that the intended recipient appliance/agent pair is adapted for printing. Accordingly, the DTV agent 1714 modifies the first action message send in the step 1808 by the user agent 1712 in order to make the second action message sent by the step 1816 intelligible to the printer agent 1716.

If the printer agent 1716 in the decision step 1818, concludes that the second action is possible for its associated printer 1708 to perform, then the process 1800 is directed in accordance with a dashed arrow 1820 which depicts that the second action is performed (eg. that the email to be printed is printed by the printer 1708). If, on the other hand, the printer agent 1716 decides in the decision step 1818 that the second action is not possible (eg. if the printer 1708 has no paper), then the process 1800 is directed in accordance with an arrow 1822 which can be directed to other appliance agents and their associated appliances (not shown).

Reviewing the process 1800, it is noted that once the DTV agent 1714 concludes that its associated appliance (ie the DTV 1706) is unable to perform the first action, it sends an intelligible action message to the second appliance agent 1716, and importantly, hands over control to that second appliance agent 1716. Thereafter, the first appliance agent 1714 no longer participates in the process and is effectively “out of the loop”. This enables the control over the desired action to flow, or propagate through a succession of appliance agents, until the action, or an equivalent thereof, can be performed.

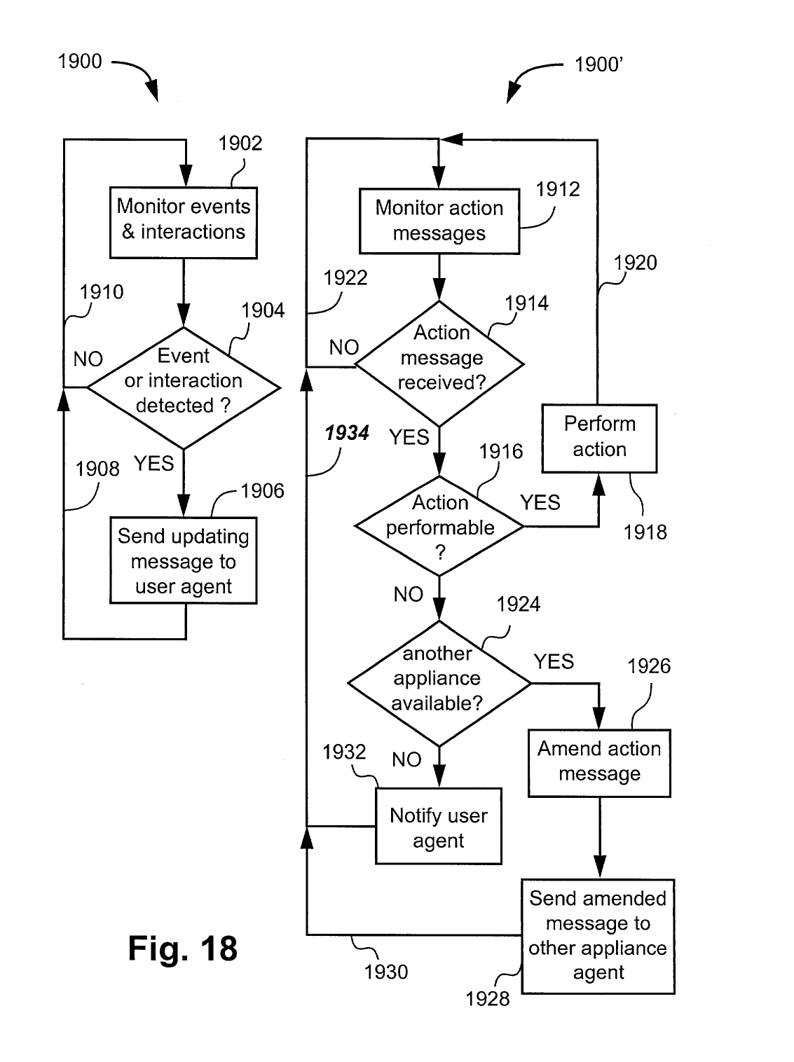

FIG. 18 is a flow chart of method steps comprising a process whereby an appliance agent (for example the DTV agent 1714) participates in control of an appliance in the multi-agent system (for example the DTV 1706, in FIG. 4). A first segment 1900 of the process includes a step 1902 which monitors, using the DTV CPU 1742 and the sensor 1746, interactions of a user with the DTV 1706, and events associated with said DTV 1706. A subsequent testing step 1904 determines whether an event or interaction has occurred. If such an event or occurrence is not detected, then the process segment 1900 is directed in accordance with a “NO” arrow back to the step 1902. If on the other hand, such an occurrence is detected, then the process segment 1900 is directed in accordance with a “YES” arrow to a step 1906 that sends an updating message to the user agent 1712 (see FIG. 4). Thereafter, the process segment 1900 is directed back to the step 1902. One example of an event relating to the DTV 1706 is the user tuning in to watch a DTV program on the DTV 1706. A corresponding updating message to the user agent 1712 includes information regarding the name of the program, the start time and the duration of the program.

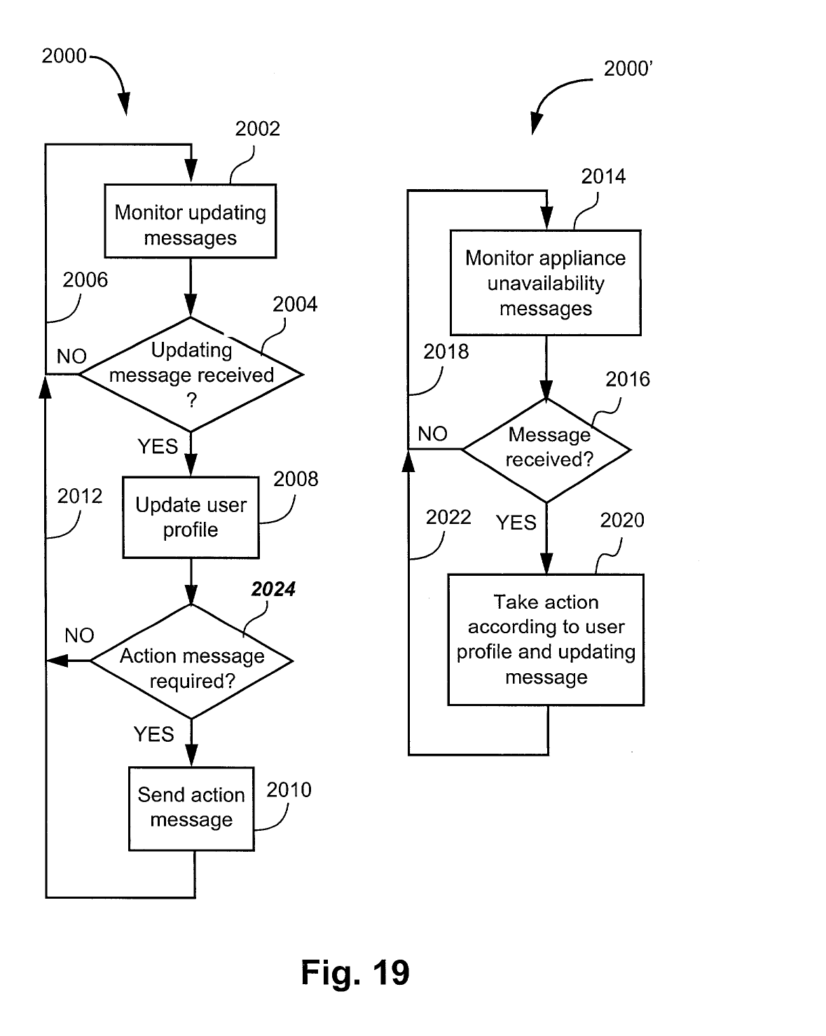

A second segment 1900′ of the process includes a step 1912 that monitors arrival of action messages from the user agent 1712. A subsequent testing step 1914 determines whether such a message has been received. If such a message is not detected, then the process segment 1900′ is directed in accordance with a “NO” arrow back to the step 1912. If on the other hand, such a message is detected, then the process segment 1900′ is directed in accordance with a “YES” arrow to a testing step 1916 that determines whether the DTV 1706 is able to perform the action associated with the received action message. If the DTV is so able, then the process segment 1900′ is directed in accordance with a “YES” arrow to a step 1918 which performs the action. As described in relation to FIG. 4, one example of the action message can be to “display an email on the screen” of the DTV 1706, this only being possible if the probability measure associated with the corresponding email category is greater than 50%. This probability measure is dependent upon the user profile kept by the user agent 1712 (see FIG. 19). If the DTV 1706 is unable to perform the desired action (for example if the probability measure is less than 50% and the user is watching the noted program on the DTV 1706), then the process segment 1900′ is directed in accordance with a “NO” arrow to a testing step 1924.

The step 1924 determines whether another appliance is available for dealing with the desired action associated with the received action message. In order to make this determination, the DTV agent 1714 interrogates the IAS application 1704 whether another appliance is available. Since each appliance specific agent is registered with the IAS 1704 when the agent is first activated in the network, and “relevant information” about the specific agent is recorded by the IAS 1704, the IAS 1704 is able to maintain a database of agents and their relevant information. Such relevant information can include, for example, the ability of an appliance to store, display or print a text message, and can also include a network address which gives an indication of geographic location. Accordingly, the IAS 1704 is able to determine whether a suitable other agent is available, and is able to inform the DTV agent 1714 as appropriate in regard to the step 1924. The IAS 1704 determines whether the other agent is suitable by using the “relevant information” about the specific agent that has been recorded by the IAS 1704. Accordingly, the IAS 1704 is able to select the printer 1708 as being suitable because it is (a) able to print the email in question, and (b) located in the same domestic premises as the DTV 1706, thus being convenient for the user.

If, as in the example above, the step 1924 determines that another appliance (ie. the printer 1708) is available, then the process segment 1900′ is directed according to a “YES” arrow to a step 1926. The step 1926 amends the action message “display the email on the screen” to “print the email on a printable medium”. This amended message is intelligible to the printer agent 1716, according to the relevant information stored in the agent database of the IAS 1704 for the printer. The step 1926 further amends the action message by setting a flag therein indicating that the DTV 1706 is unable to comply with the action message, and should not be the subject of further requests in regard to the present email. A subsequent step 1928 sends the amended action message “print the email on a printable medium” to the printer agent 1716, thereby handing over control of the email to the printer 1708. Therafter the process segment 1900′ is directed back to the step 1912.

Returning to the step 1924, if the IAS server 1704 determines that no other appliances are available (as might be the case if the printer 1708 has no paper, the UMM 1710 and the HDD 1730 have no further storage space, and no other appliances are present on the network or within the same domestic premises as the DTV 1706), then the process segment 1900′ is directed in accordance with a “NO” arrow to a step 1932. The step 1932 notifies the user agent 1712 that no other appliances are available, and also notifies the user agent what the desired action is. Thereafter, the process segment 1900′ is directed back to the step 1912.

FIG. 19 is a flow chart of method steps comprising a process whereby the user agent 1712 participates in control of appliances in the multi-agent system. A first segment 2000 of the process includes a monitoring step 2002 that monitors reception of updating messages from the DTV agent 1714, for example. A subsequent testing step 2004 determines whether such an updating message has been received. In the present example, the updating message is sent by the DTV agent 1714 and relates to the program being watched by the user. A subsequent step 2008 updates the user profile according to the updating message. Thereafter, a testing step 2024 determines whether an an action message is required. Thus for example, if the updating message relates to the user starting to watch a DTV program, no action message is required, and the only action taken by the user agent 1712 is to update the user profile in the step 2008, after which the process segment 2000 is directed in accordance with a “NO” arrow to the step 2002.

If on the other hand an action message is required, as would be the case if the updating message related to receipt by the PCA 1774 of an email, then the process segment 2000 is directed to the step 2010. The step 2010 sends an action message, dependent upon the user profile and the updating message, to an appropriate destination, in the present example being the DTV 1706 to display the email. Thereafter, the process segment 2000 is directed to the step 2002.

A second segment 2000′ of the process includes a step 2014 that monitors for receipt of “appliance unavailable” messages from the DTV appliance agent 1714 (see step 1932 in FIG. 18). A testing step 2016 determines whether any such messages have been received. If none have been received, then the process segment 2000′ is directed in accordance with a “NO” arrow to the step 2014. If on the other hand such a message is received, then a step 2020 takes appropriate action according to the nature of the desired action, and the user profile. Thus, if receipt of an email having a probability measure of 10% is the basis for the desired action, and if for example, the user profile indicates that any email with a probability measure less than 20% should be erased, the present email is dumped. Thereafter, the process segment 2000′ is directed back to the step 2014.

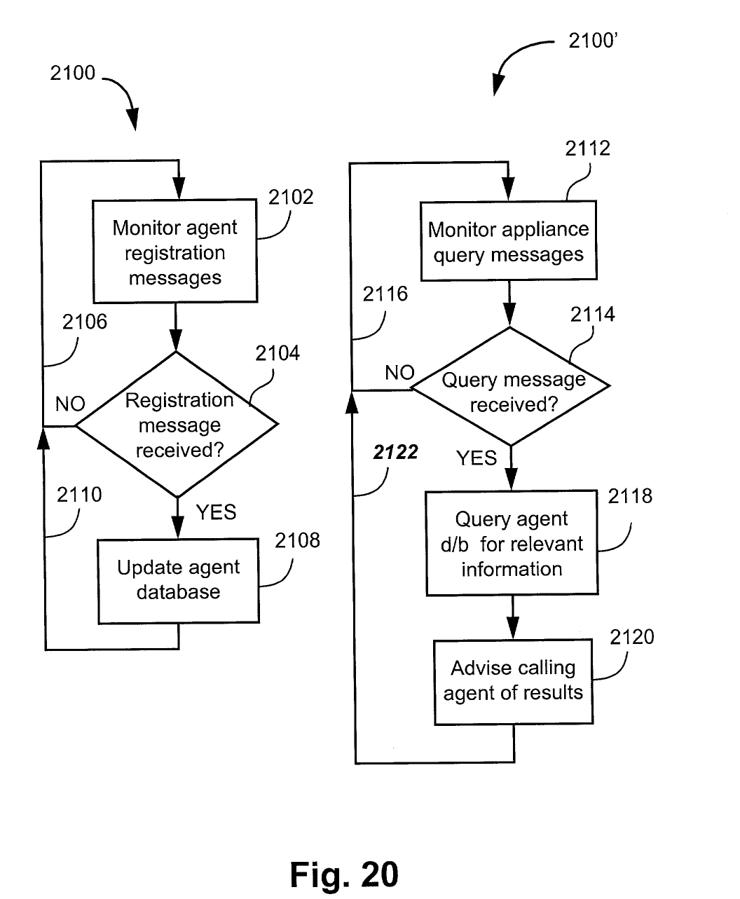

FIG. 20 is a flow chart of method steps comprising a process whereby an Inter-agent server participates in control of appliances in the multi-agent system. A first segment 2100 of the process includes a step 2102 which monitors registration messages received from appliance agents attaching to the network 1720 (see FIG. 4). A subsequent testing step 2104 determines whether a registration message has been received. If this is the case, then the process segment 2100 is directed in accordance with a “YES” arrow to a step 2108 that updates the agent database of the IAS 1704. Thereafter, the process Segment 2100 is directed back to the step 2102. If on the other hand no registration message is detected by the step 2104, then the process segment 2100 is directed in accordance with a “NO” arrow from the step 2104 to the step 2102.

A second segment 2100′ includes a step 2112 that monitors for query messages from appliance agents such as those queries emanating from the testing step 1924 in FIG. 18. A subsequent testing step 2114 determines whether such a query has been received. If this is the case, for example when the DTV agent 1714 queries in the step 1924 whether another appliance is available since the DTV 1706 cannot display the email in question, then the process segment 2100′ is directed in accordance with a “YES” arrow to a step 2118 which queries the agent database of the IAS 1704 for relevant information of various registered appliance agents. A subsequent step 2120 advises the calling appliance agent (ie. the DTV agent 1714 in this example) of the appropriate other appliance/agent pair, based upon the relevant agent information. Thereafter, the process segment 2100′ is directed back to the step 2112. Returning to the testing step 2114, if no query message is detected, then the process segment 2100′ is directed in accordance with a “NO” arrow back to the step 2112.

Industrial Applicability

It is apparent from the above that the embodiments of the invention are applicable to the computer and data processing industries, as well as the home automation industries.

The foregoing describes only some embodiments of the present invention, and modifications and/or changes can be made thereto without departing from the scope and spirit of the invention, the embodiments being illustrative and not restrictive.

1. A method for controlling a system comprising a user agent, associated with a user, and a plurality of appliances each having a corresponding appliance agent, said method comprising steps of:
sending, by the user agent, a first action message to a first appliance agent, thereby to direct a corresponding first appliance to perform a first action, wherein control over said first action thereby passes from the user agent to the first appliance agent;
performing said first action by the first corresponding appliance if said first corresponding appliance is capable of doing so; and
sending, by the first appliance agent, if the first corresponding appliance is not capable of performing the first action, a second action message dependent upon the first action message to a second appliance agent, thereby to direct a corresponding second appliance to perform a second action; wherein control over said second action thereby passes from the first appliance agent to the second appliance agent.

2. A method according to claim 1, wherein said first appliance agent makes a second action message by amending said first action message to be intelligible to the second appliance agent.

3. A method according to claim 2, wherein said first appliance agent further amends the first action message by adding information indicating that said first appliance is unable to comply with the first action message.

4. A method according to claim 1, wherein said second action is for performing the same function as that of said first action and each of said first appliance and said second appliance have the same function.

5. A method according to claim 1, wherein said first action is to be performed in regard to an object by said first appliance and said second action is a new action which is able to replace said first action as an operation for the object.

6. A system for controlling a plurality of appliances, the system including a user agent, associated with a user, and said plurality of appliances each having a corresponding appliance agent, wherein:
the user agent includes sending means for sending a first action message to a first appliance agent, thereby to direct a corresponding first appliance to perform a first action, wherein control over said first action thereby passes from the user agent to the first appliance agent; and
the first appliance agent includes sending means for sending, if the first corresponding appliance is not capable of performing the first action, a second action message dependent upon the first action message to a second appliance agent, thereby to direct a corresponding second appliance to perform a second action; wherein control over said second action thereby passes from the first appliance agent to the second appliance agent.

7. A computer program product including a computer readable medium having recorded thereon at least one computer program module for directing at least one corresponding processor to execute a method for controlling a plurality of appliances in a system comprising a user agent, associated with a user, and corresponding appliance agents for the plurality of appliances, said at least one computer program module comprising:
code for sending, by the user agent, a first action message to a first appliance agent, thereby to direct a corresponding first appliance to perform a first action, wherein control over said first action thereby passes from the user agent to the first appliance agent; and
code for sending, by the first appliance agent, if the first corresponding appliance is not capable of performing the first action, a second action message dependent upon the first action message to a second appliance agent, thereby to direct a corresponding second appliance to perform a second action; wherein control over said second action thereby passes from the first appliance agent to the second appliance agent.

8. A computer program comprising at least one computer program module for directing at least one corresponding processor to execute a method for controlling a plurality of appliances in a system comprising a user agent, associated with a user, and corresponding appliance agents for the plurality of appliances, said at least one computer program module comprising:
code for sending, by the user agent, a first action message to a first appliance agent, thereby to direct a corresponding first appliance to perform a first action, wherein control over said first action thereby passes from the user agent to the first appliance agent; and
code for sending, by the first appliance agent, if the first corresponding appliance is not capable of performing the first action, a second action message dependent upon the first action message to a second appliance agent, thereby to direct a corresponding second appliance to perform a second action; wherein control over said second action thereby passes from the first appliance agent to the second appliance agent.

9. A television signal receiving apparatus being capable of communicating with a plurality of appliances, said television signal receiving apparatus comprising a signal receiving means for receiving a television signal, a user agent associated with a user, and a plurality of appliance agents each associated with a corresponding one of said appliances, wherein:
the user agent includes sending means for sending a first action message to a first appliance agent, thereby to direct a corresponding first appliance to perform a first action, wherein control over said first action thereby passes from the user agent to the first appliance agent; and
the first appliance agent includes sending means for sending, if the first corresponding appliance is not capable of performing the first action, a second action message dependent upon the first action message to a second appliance agent, thereby to direct a corresponding second appliance to perform a second action wherein control over said second action thereby passes from the first appliance agent to the second appliance agent.

10. A method for controlling a system comprising a plurality of appliances, each said appliance having a corresponding appliance agent, and a user agent, associated with a user, said method comprising steps of:
detecting by a first appliance agent at least one of (i) an interaction of the user with a corresponding first appliance, and (ii) an event associated with said corresponding first appliance;
communicating by the first appliance agent to the user agent, an updating message dependent upon said at least one of said interaction and said event;
updating a user profile by the user agent dependent upon said updating message;
sending, by the user agent, a first action message dependent upon the user profile and upon said one of the interaction and the event to the first appliance agent, thereby to direct the corresponding first appliance to perform a first action; wherein control over said first action thereby passes from the user agent to the first appliance agent;
performing said first action by the first corresponding appliance if a first status of the first appliance so permits; and
sending, if the first status does not so permit, by the first appliance agent, a second action message dependent upon the first action message and the first status to a second appliance agent, thereby to direct a corresponding second appliance to perform a second action; wherein control over said second action thereby passes from the first appliance agent to the second appliance agent.

11. A system for controlling a plurality of appliances, each said appliance having a corresponding appliance agent, the system including a user agent, associated with a user, wherein:
(a) a first one of said corresponding appliance agents includes:
detecting means for detecting at least one of (i) an interaction of the user with a corresponding first appliance, and (ii) an event associated with said corresponding first appliance; and
communicating means for communicating to the user agent, an updating message dependent upon said at least one of said interaction and said event;
(b) the user agent includes:
updating means for updating a user profile dependent upon said updating message; and
sending means for sending a first action message dependent upon the user profile and upon said one of the interaction and the event to the first appliance agent, thereby to direct the corresponding first appliance to perform a first action; wherein control over said first action thereby passes from the user agent to the first appliance agent; and wherein:
(c) said first one of said corresponding appliance agents further includes sending means for sending, if a first status of the first corresponding appliance does not permit the first corresponding appliance to perform the first action, a second action message dependent upon the first action message and the first status to a second appliance agent, thereby to direct a corresponding second appliance to perform a second action; wherein control over said second action thereby passes from the first appliance agent to the second appliance agent.

12. A computer program product including a computer readable medium having recorded thereon at least one computer program module for directing at least one corresponding processor to execute a method for controlling a plurality of appliances in a system comprising a user agent, associated with a user, and corresponding appliance agents for the plurality of appliances, said at least one computer program module comprising:
code for detecting by a first appliance agent at least one of (i) an interaction of the user with a corresponding first appliance, and (ii) an event associated with said corresponding first appliance;
code for communicating by the first appliance agent to the user agent, an updating message dependent upon said at least one of said interaction and said event;
code for updating a user profile by the user agent dependent upon said updating message;
code for sending, by the user agent, a first action message dependent upon the user profile and upon said one of the interaction and the event to the first appliance agent, thereby to direct the corresponding first appliance to perform a first action; wherein control over said first action thereby passes from the user agent to the first appliance agent; and
code for sending, if the first status does not so permit, by the first appliance agent, a second action message dependent upon the first action message and the first status to a second appliance agent, thereby to direct a corresponding second appliance to perform a second action; wherein control over said second action thereby passes from the first appliance agent to the second appliance agent.

13. A computer program comprising at least one computer program module for directing at least one corresponding processor to execute a method for controlling a plurality of appliances in a system comprising a user agent, associated with a user, and corresponding appliance agents for the plurality of appliances, said at least one computer program module comprising:
code for detecting by a first appliance agent at least one of (i) an interaction of the user with a corresponding first appliance, and (ii) an event associated with said corresponding first appliance;
code for communicating by the first appliance agent to the user agent, an updating message dependent upon said at least one of said interaction and said event;
code for updating a user profile by the user agent dependent upon said updating message;
code for sending, by the user agent, a first action message dependent upon the user profile and upon said one of the interaction and the event to the first appliance agent, thereby to direct the corresponding first appliance to perform a first action; wherein control over said first action thereby passes from the user agent to the first appliance agent; and
code for sending, if the first status does not so permit, by the first appliance agent, a second action message dependent upon the first action message and the first status to a second appliance agent, thereby to direct a corresponding second appliance to perform a second action; wherein control over said second action thereby passes from the first appliance agent to the second appliance agent.

14. A system for controlling at least one appliance, the system comprising:
an appliance agent adapted to sense an interaction of a user with the at least one appliance;
a user agent associated with the user;
communicating means for communicating data between the appliance agent and the user agent, said data being dependent upon the interaction;
updating means for updating by the user agent a user profile in accordance with the data;
detecting means for detecting by the user agent an event associated with said at least one appliance; and
directing means for providing, by the user agent, a direction based upon at least one of the user profile and the event, to the at least one appliance if a criterion is satisfied.

15. A system according to claim 14, further comprising an inter-agent server adapted to support communication between the at least one appliance, the appliance agent and the user agent.

16. A system according to claim 15, wherein said inter-agent server comprises:
registration means adapted to register at least one of a connection and a disconnection of the appliance from the system;
messaging means adapted to support message-based communication of the data between the appliance, the appliance agent and the user agent; and
notification means for notifying at least the user agent of said connection and said disconnection of the appliance.

17. A method of controlling at least one appliance, said method comprising steps of:
sensing by an appliance agent an interaction of a user with the at least one appliance;
communicating data between the appliance agent and a user agent, said data being dependent upon the interaction;
updating by the user agent a user profile in accordance with the data;
detecting by the user agent an event associated with said at least one appliance; and
providing, by the user agent, a direction based upon at least one of the user profile and the event, to the at least one appliance if a criterion is satisfied.

18. A computer readable medium for storing a program for a system for controlling at least one appliance, said program comprising:
code for a sensing step for sensing by an appliance agent an interaction of a user with the at least one appliance;
code for a communicating step for communicating data between the appliance agent and a user agent, said data being dependent upon the interaction;
code for an updating step for updating by the user agent a user profile in accordance with the data;
code for a detecting step for detecting by the user agent an event associated with said at least one appliance; and
code for a providing step for providing, by the user agent, a direction based upon at least one of the user profile and the event, to the at least one appliance if a criterion is satisfied.

19. A user agent computer program for directing a processor to execute a method for controlling an appliance having an associated appliance agent computer program, the user agent program comprising:
code for receiving an updating message from the appliance agent, said updating message being dependent upon at least one of (i) an interaction of a user with the appliance, and (ii) an event associated with said appliance;
code for updating a user profile dependent upon the updating message; and
code for sending an action message dependent upon the user profile and said at least one of (i) the interaction and (ii) the event, to the appliance agent, thereby to direct the appliance to perform a first action, wherein control over said first action thereby passes from the user agent to the appliance agent.

20. A computer program product including a computer readable medium having recorded thereon a user agent computer program for directing a processor to execute a method for controlling an appliance having an associated appliance agent computer program, the user agent program comprising:
code for receiving an updating message from the appliance agent, said updating message being dependent upon at least one of (i) an interaction of a user with the appliance, and (ii) an event associated with said appliance;
code for updating a user profile dependent upon the updating message; and
code for sending an action message dependent upon the user profile and said at least one of (i) the interaction and (ii) the event, to the appliance agent, thereby to direct the appliance to perform a first action, wherein control over said first action thereby passes from the user agent to the appliance agent.

21. An appliance agent computer program associated with an appliance, said program adapted for directing a processor of the appliance to execute a method for controlling the appliance, the program comprising:
code for receiving a first action message from a user agent;
code for directing the appliance to perform a first action based upon the first action message;
code for amending the first action message to be intelligible to other appliance agent, if the appliance is unable to perform the first action; and
code for sending the amended action message to the other appliance agent, wherein control over said first action thereby passes to the other appliance agent.

22. An appliance agent program according to claim 21, said program further comprising:
code for detecting at least one of (i) an interaction of a user with the appliance, and (ii) an event associated with said appliance; and
code for sending an updating message dependent upon said at least one of (i) the interaction and (ii) the event, to said user agent.

23. A computer program product including a computer readable medium having recorded thereon an appliance agent computer program associated with an appliance, said program adapted for directing a processor of the appliance to execute a method for controlling the appliance, the program comprising:
code for receiving a first action message from a user agent;
code for directing the appliance to perform a first action based upon the first action message;
code for amending the first action message to be intelligible to another appliance agent, if the appliance is unable to perform the first action; and
code for sending the amended action message to the other appliance agent, wherein control over said first action thereby passes to the other appliance agent.

24. An inter agent server computer program adapted for directing a processor of an appliance to execute a method for controlling the appliance, the program comprising:
code for receiving a query from an appliance agent, said query requesting identification of a suitable alternate appliance to perform an action;
code for querying an inter agent server database to thereby identify said suitable alternate appliance on the basis of relevant information for a plurality of alternate appliances registered by the inter agent server;
code for selecting the suitable alternate appliance on the basis of the action; and
code for advising the appliance agent of the suitable alternate appliance.

25. A computer program product including a computer readable medium having recorded thereon an appliance agent computer program associated with an appliance, said program adapted for directing a processor of the appliance to execute a method for controlling the appliance, the program comprising:
code for receiving a query from an appliance agent, said query requesting identification of a suitable alternate appliance to perform an action;
code for querying an inter agent server database to thereby identify said suitable alternate appliance on the basis of relevant information for a plurality of alternate appliances registered by the inter agent server;
code for selecting the suitable alternate appliance on the basis of the action; and
code for advising the appliance agent of the suitable alternate appliance.

26. An appliance including an appliance agent computer program as claimed in claim 21.
